(19) United States
(12) Patent Application Publication
(10) Pub. No.: US 2019/0082436 A1
(43) Pub. Date: Mar. 14, 2019

(54) UPLINK INFORMATION TRANSMISSION METHOD, BASE STATION, AND USER EQUIPMENT

(71) Applicant: HUAWEI TECHNOLOGIES CO., LTD., Shenzhen (CN)

(72) Inventor: Qufang HUANG, Shanghai (CN)

(73) Assignee: HUAWEI TECHNOLOGIES CO., LTD., Shenzhen (CN)

(21) Appl. No.: 16/185,436

(22) Filed: Nov. 9, 2018

Related U.S. Application Data
(63) Continuation of application No. PCT/CN2016/081555, filed on May 10, 2016.

(51) Int. Cl. H04W 72/04; H04W 16/32; H04W 16/14

(52) U.S. Cl. CPC H04W 72/0413; H04W 16/14; H04W 16/32

(57) ABSTRACT

Embodiments of the present invention provide an uplink information transmission method, an apparatus, and user equipment. The base station configures a cell group for the UE, and sends configuration information of the cell group to the UE, so that the UE sends uplink information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

### CROSS-REFERENCE TO RELATED APPLICATIONS

This application is a continuation of International Application No. PCT/CN2016/081555, filed on May 10, 2016, the disclosure of which is hereby incorporated by reference in its entirety.

### TECHNICAL FIELD

Embodiments of the present invention relate to data transmission technologies, and in particular, to an uplink information transmission method, a base station, and user equipment.

### BACKGROUND

To alleviate insufficiency of spectrum resources, the 3rd Generation Partnership Project (3rd Generation Partnership Project, 3GPP) uses unlicensed spectrums to provide wireless communication services. Depending on whether a licensed spectrum cell and an unlicensed spectrum cell are deployed in a co-site manner, there are two deployment manners: Manner 1: Co-site deployment of a licensed spectrum cell and an unlicensed spectrum cell. In this case, for a specific base station, cells of a base station include a licensed spectrum cell and an unlicensed spectrum cell. Manner 2: Non co-site deployment of a licensed spectrum cell and an unlicensed spectrum cell. In this case, at least one base station exists, and cells of the base station are all unlicensed spectrum cells.

In a carrier aggregation (Carrier Aggregation, CA) technology, user equipment (User Equipment, UE) simultaneously uses a plurality of cells of the base station to transmit data, so as to improve a data transmission speed. In the plurality of cells, one is a primary cell (Primary Cell, PCell) and the rest are secondary cells (Secondary Cell, SCell). Generally, CA may be classified into intra-base-station cell aggregation, inter-base-station cell aggregation, and the like. The intra-base-station cell aggregation means that, for one UE, to-be-aggregated serving cells belong to a same base station. The inter-base-station cell aggregation means that, for one UE, to-be-aggregated serving cells belong to a plurality of different base stations (current standard protocols support only two base stations). A serving base station in which the PCell is located is a master eNB (Master eNB, MeNB), and other serving base stations are secondary eNBs (Secondary eNB, SeNB). In one or more SCells of a secondary base station, one cell is a primary secondary cell (Primary Secondary Cell, PSCell). Generally, uplink information includes uplink control information and uplink data information. The SCell is configured to transmit the uplink data information. In addition to the uplink data information, the PCell transmits the uplink control information for other SCells that transmit the uplink data information.

When unlicensed spectrum cells are deployed in the manner 1, in an uplink information transmission process, an unlicensed spectrum cell in an aggregated serving cell serves as an SCell, and transmits only uplink data information of UE. All uplink control information of the UE is transmitted by using a licensed spectrum cell PCell. If the PCell is a narrowband cell, a limited capacity of the narrowband cell may lead to a limited capacity of the PCell, and the PCell transmits limited uplink control information. This further affects transmission of the uplink data information by the SCell, and results in poor reliability of uplink information transmission. When unlicensed spectrum cells are deployed in the manner 2, all cells of one base station are unlicensed spectrum cells. At present, no uplink information transmission method is proposed for such a scenario, Therefore, in the CA technology, how to transmit uplink information is actually a problem to be urgently resolved in the industry.

### SUMMARY

Embodiments of the present invention provide an uplink information transmission method, a base station, and user equipment, to distribute uplink information to a plurality of cells in a cell group for transmission, thereby implementing high-reliability transmission of the uplink information.

According to an aspect, an embodiment of the present invention provides an uplink information transmission method, and the method is described from a perspective of user equipment. In the method, user equipment receives configuration information that is about a cell group and that is sent by a base station, and sends uplink information based on the configuration information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

In a possible implementation, for a specific cell in the cell group, uplink information of the cell is distributed to the cell or another cell, so that uplink information of the entire cell group is distributed to a plurality of cells in the cell group for transmission. This resolves the problem of a limited PCell capacity. In this case:

In a possible implementation, a second cell is an unlicensed spectrum cell, and before the sending, by the UE, uplink information of a first cell to the base station by using the second cell, the method further includes: determining, by the UE, that the second cell is an available unlicensed spectrum cell.

In a possible implementation, a second cell is an unlicensed spectrum cell, and before the sending, by the UE, uplink information of a first cell to the base station by using a second cell, the method further includes: determining, by the UE, that the second cell is an unavailable unlicensed spectrum cell.

When the second cell is an unlicensed spectrum cell, the sending, by the UE, uplink information of a first cell to the base station by using the second cell includes: starting, by the UE, a window tinier at a time point of sending the uplink information of the first cell; detecting, by the UE during running of the window timer, that the second cell is available; and sending, by the UE, the uplink information of the first cell to the base station by using the second cell. In this way, when uplink information is transmitted by using an unlicensed spectrum cell, when the unlicensed spectrum cell is detected to be unavailable, the transmission is stopped or a window timer is started. When the unlicensed spectrum cell is detected, in the window timer, to be available, the uplink information transmission continues. Therefore, reliability of uplink information transmission by using an unlicensed spectrum cell is improved.

In a possible implementation, the sending, by the UE, uplink information of a first cell to the base station by using the second cell includes: determining, by the UE, that there is an available alternative cell in at least one alternative cell of the second cell; and sending, by the UE, the uplink information of the first cell to the base station by using the available alternative cell of the second cell. By configuring a plurality of alternative cells for an unlicensed spectrum cell, reliability of uplink information transmission is improved.

In a possible implementation, the method further includes: determining, by the UE, a radio link monitoring RLM group; sequentially performing, by the UE, RLM on cells in the RLM cell group; determining, by the UE based on the RLM, that the cells in the RLM group are all unavailable; and starting, by the UE, an RLM timer, and detecting, during running of the RLM timer, whether there is an available unlicensed spectrum cell in the RLM cell group; and stopping the RLM timer if there is an available unlicensed spectrum cell in the RLM cell group, or if there is no available unlicensed spectrum cell in the RLM cell group, determining, after the RLM timer expires, that a radio link failure RLF occurs in all unlicensed spectrum cells in the RLM cell group. In the method, radio signals of a plurality of cells in the RLM group are detected, and the RLF is only considered to occur when signals of all cells are unavailable and the situation has lasted for a period of time. This increases an RLF determining threshold, improves availability of unlicensed spectrum cells, and resolves a problem of RLF misjudgment caused by unavailability of the unlicensed spectrum cells.

In a possible implementation, the method further includes: determining, by the UE, an uplink time reference group; and determining, by the UE, whether there is an available unlicensed spectrum cell in the uplink time reference group; and if there is an available unlicensed spectrum cell in the uplink time reference group, selecting one from the available unlicensed spectrum cell as an uplink time reference, or if there is no available unlicensed spectrum cell in the uplink reference time group, starting, by the UE, an uplink transmit timer, and detecting, during running of the uplink transmit timer, whether there is an available unlicensed spectrum cell in the uplink time reference group; and if there is an available unlicensed spectrum cell in the uplink time reference group, stopping the uplink transmit timer, or if there is no available unlicensed spectrum cell in the uplink time reference group, determining, after the uplink transmit timer expires, that the UE and the base station are asynchronous. In the method, when all cells in the uplink time reference group are unavailable and after the timer expires, the UE determines that the UE and the base station are asynchronous, and further abandons sending the uplink information. This resolves a problem that the UE sends the uplink time reference because of unavailability of the unlicensed spectrum cells.

In a possible implementation, the uplink time reference group further includes a licensed spectrum cell, and the method further includes: receiving, by the UE, a time difference sent by the base station, where the time difference indicates a subframe boundary difference between the licensed spectrum cell and each unlicensed spectrum cell in the uplink time reference group; and after the determining, by the UE after the uplink transmit timer expires, that the UE and the base station are asynchronous, the method further includes: determining, by the UE, an uplink transmit time reference based on the licensed spectrum cell and the time difference. In the method, the uplink time reference group further includes the licensed spectrum cell. When all cells in the uplink time reference group are unavailable and the timer expires, the UE uses the licensed spectrum cell as the time reference, and uses the “time difference” together with a downlink subframe boundary of the licensed spectrum cell as the uplink transmit time reference. This resolves the problem that the UE sends the uplink time reference because of unavailability of the unlicensed spectrum cells.

In a possible implementation, the method further includes: determining, by the UE, a third cell from the cell group based on a Single Cell Point To Multipoint SC-PTM priority, where the third cell is a cell with a highest SC-PTM priority in the cell group, or the third cell is a cell with a lowest SC-PTM priority in the cell group; and receiving, by the UE in one multicast control channel MCCH period by using the third cell, a single cell multi cast control channel SC-MCCH message sent by the base station. In the method, a plurality of unlicensed spectrum cells are bound together to collaboratively send an SC-MCCH or an SC-MTCH, thereby improving a success rate of transmission.

In a possible implementation, after the receiving, by the UE in one multicast control channel MCCH period by using the third cell, a single cell multicast control channel SC-MCCH message sent by the base station, the method further includes: determining, by the UE based on the SC-MCCH, an SC-MTCH window for sending SC-MTCH information by the base station; determining, by the UE, a fourth cell from the cell group based on the SC-PTM priority; and receiving, by the UE by using the fourth cell, the SC-MTCH information sent by the base station in the SC-MTCH.

In a possible implementation, before the sending, by the UE, uplink information to the base station by using the cell group, the method further includes: receiving, by the UE by using a fifth cell in the cell group, downlink data sent by the base station, where the fifth cell is an unlicensed spectrum cell; and determining, by the UE, a sixth cell from the cell group, where the sixth group is a cell that occurs earliest within a hybrid automatic repeat request window HARQ windows time of the downlink data and that has an available physical uplink shared channel PUCCH opportunity; and the sending, by the UE, uplink information to the base station by using the cell group includes: sending, by the UE, a HARQ of the downlink data to the base station by using the PUCCH opportunity of the sixth cell. In the method, the UE can send the HARQ by selecting one cell from the cell group. Compared with the prior-art practice of sending the HARQ only by using the PUCCH of the PCell, this improves a probability of feeding back the HARQ by the UE.

In a possible implementation, before the sending, by the UE, uplink information to the base station by using the cell group, the method further includes:

determining, by the UE, a channel state indication CSI resource.

In a possible implementation, the determining, by the UE, a CSI resource includes:

receiving, by the UE, first CSI resource indication information sent by the base station, where the first CSI resource indication information indicates a time position of the CSI resource; and

reserving, by the UE based on the first CSI resource indication information, the time position in each cell of the cell group as a position of the CSI resource.

In a possible implementation, the determining, by the UE, a CSI resource includes:

receiving, by the UE, second CSI resource indication information sent by the base station, where the second CSI resource indication information indicates a time position of the CSI resource and a seventh cell; and

reserving, by the UE based on the second indication information, the time position in the seventh cell as a position of the CSI resource.

According to another aspect, an embodiment of the present invention provides an uplink information transmission method and the method is described from a perspective of a base station. In this method, a base station configures a cell group for UE, and sends configuration information of the cell group to the UE, so that the UE sends uplink information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

In a possible implementation, the uplink information includes uplink information of a first cell, and the receiving, by the base station, uplink information sent by the UE by using the cell group includes: receiving, by the base station, the uplink information of the first cell sent by the UE by using the first cell; or receiving, by the base station, the uplink information of the first cell sent by the UE by using a second cell; where the first cell is a cell in the cell group, and the second cell is another cell different from the first cell in the cell group.

In a possible implementation, the second cell is an unlicensed spectrum cell, and the receiving, by the base station, the uplink information of the first cell sent by the UE by using a second cell includes:

receiving, by the base station, the uplink information of the first cell sent by the UE by using the second cell after the UE determines that the second cell is an available unlicensed spectrum cell.

In a possible implementation, the second cell is an unlicensed spectrum cell, and the receiving, by the base station, the uplink information of the first cell sent by the UE by using a second cell includes:

receiving, by the base station, the uplink information of the first cell sent by the UE by using an available alternative cell of the second cell, where the available alternative cell is determined by the UE from at least one alternative cell of the second cell after the UE determines that the second cell is an unavailable unlicensed spectrum cell.

In a possible implementation, the method further includes:

sending, by the base station in one multicast control channel MCCH period, downlink control information to the UE by using a third cell and a single cell multicast control channel SC-MCCH, where the third cell is determined by the UE from the cell group based on an SC-PTM priority, and the third cell is a cell with a highest SC-PTM priority in the cell group, or the third cell is a cell with a lowest SC-PTM priority in the cell group.

In a possible implementation, the method further includes:

sending, by the base station by using a fourth cell, downlink data information to the UE in a single cell multicast traffic channel SC-MTCH window by using an SC-MTCH, where the fourth cell is determined by the UE from the cell group based on the SC-PTM priority.

In a possible implementation, before the receiving, by the base station, uplink information sent by the UE by using the cell group, the method further includes:

sending, by the base station, downlink data to the UE by using a fifth cell in the cell group; and

the receiving, by the base station, uplink information sent by the UE by using the cell group includes:

receiving., by the base station, a hybrid automatic repeat request HARQ of the downlink data that is sent by the UE to the base station by using a PUCCH opportunity of a sixth cell, where the sixth cell is determined by the UE from the cell group, and the sixth cell is a cell that occurs earliest within a hybrid automatic repeat request window HARQ windows time of the downlink data and that has an available physical uplink shared channel PUCCH opportunity.

In a possible implementation, before the receiving, by the base station, uplink information sent by the UE by using the cell group, the method further includes:

sending, by the base station, first CSI resource indication information to the UE, where the first CSI resource indication information indicates a time position of the CSI resource.

In a possible implementation, before the receiving, by the base station, uplink information sent by the UE by using the cell group, the method further includes:

sending, by the base station, second CSI resource indication information to the UE, where the second CSI resource indication information indicates a time position of the CSI resource and a seventh cell.

According to still another aspect, an embodiment of the present invention provides user equipment, including:

a receiving module, configured to receive configuration information sent by a base station, where the configuration information indicates a cell group configured for the UE by the base station; and

a sending module, configured to send uplink information to the base station by using the cell group.

In a possible implementation, the uplink information includes uplink information of a first cell; and

the sending module is specifically configured to send the uplink information of the first cell to the base station by using the first cell;

or,

the sending module is specifically configured to send the uplink information of the first cell to the base station by using a second cell; where

the first cell is a cell in the cell group, and the second cell is another cell different from the first cell in the cell group.

In a possible implementation, the second cell is an unlicensed spectrum cell; and

the user equipment further includes:

a processing module, configured to determine, before the sending module sends the uplink information of the first cell to the base station by using the second cell, that the second cell is an available unlicensed spectrum cell.

In a possible implementation, the second cell is an unlicensed spectrum cell; and

the user equipment further includes:

a processing module, configured to determine, before the sending module sends the uplink information of the first cell to the base station by using the second cell, that the second cell is an unavailable unlicensed spectrum cell.

In a possible implementation, the sending module is configured to send the uplink information of the first cell to the base station by using the second cell when the processing module detects, during running of a window timer that is started at a time point of sending the uplink information of the first cell, that the second cell is available.

In a possible implementation, the sending module is configured to send, when the processing module determines that there is an available alternative cell in at least one alternative cell of the second cell, the uplink information of the first cell to the base station by using the available alternative cell of the second cell.

In a possible implementation, the processing module is further configured to: determine a radio link monitoring RLM group, and sequentially perform RLM on cells in the RLN cell group; determine, based on the RLM, that the cells in the RLM group are all unavailable; start an RLM timer; detect, during running of the RLM timer, whether there is an available unlicensed spectrum cell in the RLM cell group; and stop the RLM timer if there is an available unlicensed spectrum cell in the RLM cell group; or if there is no available unlicensed spectrum cell in the RLM cell group; determine, after the RLM timer expires, that a radio link failure RLF occurs in all unlicensed spectrum cells in the RLM cell group.

In a possible implementation, the processing module is further configured to: determine an uplink time reference group; determine whether there is an available unlicensed spectrum cell in the uplink time reference group; and if there is an available unlicensed spectrum cell in the uplink time reference group, select one from the available unlicensed spectrum cell as an uplink time reference; or if there is no available unlicensed spectrum cell in the uplink time reference group, start an uplink transmit timer, and detect, during running of the uplink transmit timer, whether there is an available unlicensed spectrum cell in the uplink time reference group, and if there is an available unlicensed spectrum cell in the uplink time reference group, stop the uplink transmit timer, or if there is no available unlicensed spectrum cell in the uplink time reference group, determine, after the uplink transmit timer expires, that the UE and the base station are asynchronous.

In a possible implementation, the uplink time reference group further includes a licensed spectrum cell, and the receiving module is further configured to: receive a time difference sent by the base station, where the time difference indicates a subframe boundary difference between the licensed spectrum cell and each unlicensed spectrum cell in the uplink time reference group; and determine an uplink transmit time reference based on the licensed spectrum cell and the time difference after it is determined, after the uplink transmit timer expires, that the UE and the base station are asynchronous.

In a possible implementation, the processing module is further configured to determine, based on a Single Cell Point To Multipoint SC-PTM priority, a third cell from the cell group, where the third cell is a cell with a highest SC-PTM priority in the cell group, or the third cell is a cell with a lowest SC-PTM priority in the cell group; and

the receiving module is configured to receive, in one multicast control channel MCCH period by using the third cell, a single cell multicast control channel SC-MCCH message sent by the base station.

In a possible implementation, the processing module is further configured to: after the receiving module receives, in one multicast control channel MCCH period by using the third cell, a single cell multicast control channel SC-MCCH message sent by the base station, determine, based on the SC-MCCH, an SC-MTCH window for sending SC-MTCH information by the base station, and determine, based on the SC-PTM priority, a fourth cell from the cell group; and

the receiving module is further configured to receive, by using the fourth cell, the SC-MTCH information sent by the base station in the SC-MTCH.

In a possible implementation, the receiving module is further configured to: before the sending module sends the uplink information to the base station by using the cell group, receive, by using a fifth cell in the cell group, downlink data sent by the base station, where the fifth cell is an unlicensed spectrum cell;

the processing module is further configured to determine a sixth cell from the cell group, where the sixth group is a cell that occurs earliest within a hybrid automatic repeat request window HARQ windows time and that has an available physical uplink shared channel PUCCH opportunity; and

the sending module is further configured to send a HARQ of the downlink data to the base station by using the PUCCH opportunity of the sixth cell.

In a possible implementation, the processing module is further configured to: before the sending module sends the uplink information to the base station by using the cell group, determine a channel state indication CSI resource.

In a possible implementation, the receiving module is further configured to receive first CSI resource indication information sent by the base station, where the first CSI resource indication information indicates a time position of the CSI resource; and

the receiving module is specifically configured to reserve, based on the first CSI resource indication information, the time position in each cell of the cell group as a position of the CSI resource.

In a possible implementation, the receiving module is further configured to receive second CSI resource indication information sent by the base station, where the second CSI resource indication information indicates a time position of the CSI resource and a seventh cell; and

the processing module is further configured to reserve, based on the second indication information, the time position in the seventh cell as a position of the CSI resource.

According to yet another aspect, an embodiment of the present invention provides a base station, including:

a processing module, configured to configure a cell group for user equipment UE;

a sending module, configured to send configuration information to the UE, where the configuration information indicates the cell group; and

a receiving module, configured to receive uplink information sent by the UE by using the cell group.

In a possible implementation, the uplink information includes uplink information of a first cell; and

the receiving module is specifically configured to receive the uplink information of the first cell sent by the UE by using the first cell;

or,

the receiving module is specifically configured to receive the uplink information of the first cell sent by the UE by using a second cell; where

the first cell is a cell in the cell group, and the second cell is another cell different from the first cell in the cell group.

In a possible implementation, the second cell is an unlicensed spectrum cell; and

the receiving module is specifically configured to receive the uplink information of the first cell sent by using the second cell after the UE determines that the second cell is an available unlicensed spectrum cell,

In a possible implementation, the second cell is an unlicensed spectrum cell; and

the receiving module is specifically configured to receive the uplink information of the first cell sent by the UE by using an available alternative cell of the second cell, where the available alternative cell is determined by the UE from at least one alternative cell of the second cell after the UE determines that the second cell is an unavailable unlicensed spectrum cell.

In a possible implementation, the sending module is further configured to send, in one multicast control channel MCCH period, downlink control information to the UE by using a third cell and a single cell multicast control channel SC-MCCH, where the third cell is determined by the UE from the cell group based on an SC-PTM priority, and the third cell is a cell with a highest SC-PTM priority in the cell group, or the third cell is a cell with a lowest SC-PTM priority in the cell group.

In a possible implementation, the sending module is further configured to send, by using a fourth cell, downlink data information to the UE in a single cell multicast traffic channel SC-MTCH window by using an SC-MTCH, where the fourth cell is determined by the UE from the cell group based on the SC-PTM priority.

In a possible implementation, the sending module is further configured to: before the receiving module receives the uplink information sent by the UE by using the cell group, send downlink data to the UE by using a fifth cell in the cell group; and

the receiving module is configured to receive a hybrid automatic repeat request HARQ of the downlink data that is sent by the UE to the base station by using a PUCCH opportunity of a sixth cell, where the sixth cell is determined by the UE from the cell group, and the sixth cell is a cell that occurs earliest within a hybrid automatic repeat request window HARQ windows time of the downlink data and that has an available physical uplink shared channel PUCCH opportunity.

In a possible implementation, the sending module further sends, before the receiving module receives the uplink information sent by the UE by using the cell group, first CSI resource indication information to the UE, where the first CSI resource indication information indicates a time position of the CSI resource.

In a possible implementation, the sending module further sends, before the receiving module receives the uplink information sent by the UE by using the cell group, second CSI resource indication information to the UE, where the second CSI resource indication information indicates a time position of the CSI resource and a seventh cell.

According to yet another aspect, an embodiment of the present invention provides user equipment, including: a processor, a memory, a communications interface, and a system bus, where the memory and the communications interface are connected to and communicate with the processor by using the system bus, the memory is configured to store a computer-executable instruction, the communications interface is configured to communicate with another device, and the processor is configured to run the computer-executable instruction, to cause the user equipment to perform the steps of the foregoing method applied to user equipment.

According to yet another aspect, an embodiment of the present invention provides a base station, including: a processor, a memory, a communications interface, and a system bus, where the memory and the communications interface are connected to and communicate with the processor by using the system bus, the memory is configured to store a computer-executable instruction, the communications interface is configured to communicate with another device, and the processor is configured to run the computer-executable instruction, to cause the base station to perform the steps of the foregoing method applied to a base station.

According to the uplink information transmission method, the apparatus, and the user equipment provided by the embodiments of the present invention, the base station configures the cell group for the UE, and sends configuration information of the cell group to the UE, so that the UE sends the uplink information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

### BRIEF DESCRIPTION OF DRAWINGS

FIG. 1 is a schematic diagram of a network architecture to which an uplink information transmission method according to the present invention is applicable;

FIG. 2 is a flowchart of Embodiment 1 of an uplink information transmission method according to the present invention;

FIG. 3 is a schematic diagram of a CQI reporting process in Embodiment 2 of an uplink information transmission method according to the present invention;

FIG. 4 is a schematic diagram of reporting uplink information by using an unlicensed spectrum cell in Embodiment 3 of an uplink information transmission method according to the present invention;

FIG. 5 is a flowchart of reporting uplink information by using an alternative cell of an unlicensed spectrum cell in Embodiment 4 of an uplink information transmission method according to the present invention;

FIG. 6 is a schematic diagram of uplink data information transmission in an uplink information transmission method according to the present invention;

FIG. 7 is a schematic diagram of monitoring RLM by UE by using an RLM cell group in an uplink information transmission method according to the present invention;

FIG. 8 is a schematic diagram of using, by UE, an unlicensed spectrum cell as an uplink time reference in an uplink information transmission method according to the present invention;

FIG. 9 is a schematic diagram of determining, by UE, an uplink time reference by using a licensed spectrum cell and a time difference, in an uplink information transmission method according to the present invention;

FIG. 10 is a schematic diagram of sending an SC-MCCH in an uplink information transmission method according to the present invention;

FIG. 11 is a schematic diagram of sending an SC-MTCH message in an uplink information transmission method according to the present invention;

FIG. 12A shows a PUCCH when cells are synchronous according to an uplink information transmission method of the present invention;

FIG. 12B shows a PUCCH when cells are asynchronous according to an uplink information transmission method of the present invention;

FIG. 13 is a schematic structural diagram of Embodiment 1 of user equipment according to the present invention;

FIG. 14 is a schematic structural diagram of Embodiment 1 of a base station according to the present invention;

FIG. 15 is a schematic structural diagram of Embodiment 2 of user equipment according to the present invention; and

FIG. 16 is a schematic structural diagram of Embodiment 2 of a base station according to the present invention.

### DESCRIPTION OF EMBODIMENTS

Generally, depending on whether a licensed spectrum cell and an unlicensed spectrum cell are deployed in a co-site manner, manners for deploying an unlicensed spectrum cell are classified into the following two types: Manner 1: Co-site deployment of a licensed spectrum cell and an unlicensed spectrum cell; and Manner 2: Non co-site deployment of a licensed spectrum cell and an unlicensed spectrum cell. Unlicensed spectrum cells are introduced in a CA technology. In an uplink information (including uplink control information and uplink data information transmission process, when the manner 1 is used, an SCell, mainly an unlicensed spectrum cell, in an aggregated serving cell transmits only uplink data information. All uplink control information of the cell is transmitted by using a licensed spectrum cell PCell. If the PCell is a narrowband cell, a limited capacity of the narrowband cell may lead to a limited capacity of the PCell, and the PCell transmits limited uplink control information. This further affects transmission of the uplink data information by the SCell, and results in poor reliability of uplink information transmission. When the manner 2 is used, all cells of one base station are unlicensed spectrum cells. At present, no uplink information transmission method is proposed for such a scenario.

For the manner 1, to resolve a problem of the limited capacity of the PCell, a current possible manner is to reduce uplink information reporting. By using that the uplink information is specifically uplink control information, and the uplink control information is specifically a channel quality indicator (Channel Quality Indicator, CQI) as an example, to enable an eNB to know an attenuation condition of subcarriers of a downlink channel in a real-time manner. UE is usually required to report the CQI once every 5 ms, so that the eNB makes an optimal downlink scheduling decision. However, due to the limited capacity of the PCell, the CQI reporting is reduced and the UE reports once every 20 ms. In this case, a basis for making the downlink scheduling decision by the eNB is a channel state that is 20 ms before and that is of a relatively large deviation from a current channel state. Therefore, it is not possible to select a minimal subcarrier for downlink data transmission, thereby affecting a downlink throughput.

In view of this, embodiments of the present invention provide an uplink information transmission method, a base station, and user equipment, to implement high-reliability transmission of uplink information by dispersing the uplink information to a plurality of cells of a cell group, for transmission.

Technologies described in this specification may be applied to various communications systems, for example, current 2G and 3G communications systems and a next-generation communications system, for example, a Global System for Mobile Communications (Global System for Mobile communications, GSM), a Code Division Multiple Access (Code Division Multiple Access, CDMA) system, a Time Division Multiple Access (Time Division Multiple Access, TDMA) system, a Wideband Code Division Multiple Access (Wideband Code Division Multiple Access Wireless, WCDMA) system, a Frequency Division Multiple Access (Frequency Division Multiple Address, FDMA) system, an Orthogonal Frequency-Division Multiple Access (Orthogonal Frequency-Division Multiple Access, OFDMA) system, a single-carrier FDMA (SC-FDMA) system, a General Packet Radio Service (General Packet Radio Service, GPRS) system, a Long Term Evolution (Long Term Evolution, LTE) system, an E-UTRA system, and other communications systems.

A terminal in this application may be a wired terminal or a wireless terminal. The wireless terminal may refer to a device that provides a user with voice and/or data connectivity, a handheld device with a radio connection function, or another processing device connected to a radio modem. The wireless terminal may communicate with one or more core networks through a radio access network (such as RAN, Radio Access Network). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, it may be a device such as a personal communications service (Personal Communication Service, PCS) phone, a cordless telephone set, a Session Initiation Protocol (SIP) phone, a wireless local loop (Wireless Local Loop, WLL) station, or a personal digital assistant (Personal Digital Assistant, PDA). The wireless terminal may also be referred to as a system, a subscriber unit (Subscriber Unit), a subscriber station (Subscriber Station), a mobile station (Mobile Station), a mobile station (Mobile), a remote station (Remote Station), a remote terminal (Remote Terminal), an access terminal (Access Terminal), a user terminal (User Terminal), a user agent (User Agent), a user device (User Device), or user equipment (User Equipment).

A base station in this application may be a device that communicates with the wireless terminal over an air interface in an access network by using one or more sectors. The base station may be configured to mutually convert a received over-the-air frame and an IP packet and serve as a router between the wireless terminal and a rest portion of the access network, where the rest portion of the access network may include an Internet protocol (IP) network. The base station may further coordinate attribute management of the air interface. For example, the base station may be a base station (Base Transceiver Station, BTS) in GSM or the CDMA, may also be a base station (NodeB) in WCDMA, and may further be an evolved NodeB (NodeB, eNB, or e-NodeB, evolutional Node B) in the LTE, which is not limited in this application.

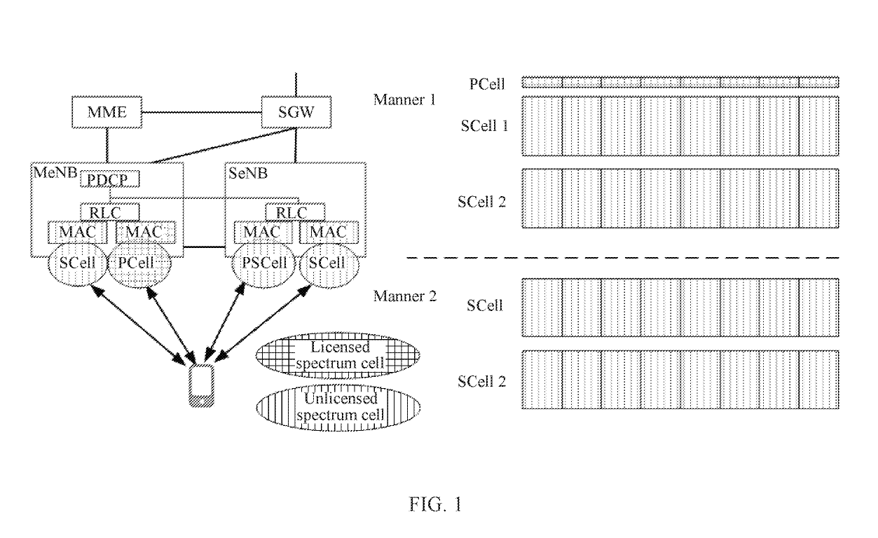

For ease of description and clarity, the following describes the technical solutions of the present invention in detail by using that a system architecture is specifically an LTE system and a base station is specifically an eNB as an example. For details, refer to FIG. 1.

FIG. 1 is a schematic diagram of a network architecture to which an uplink information transmission method according to the present invention is applicable. As shown in FIG. 1, the network includes a mobile management entity (Mobile Management Entity, MME), a serving gateway (Service Gateway, S-GW), an MeNB, an SeNB, and the like. The MeNB includes a packet data convergence protocol (Packet Data Convergence Protocol, PDCP) layer, a radio link control (Radio Link Control. RLC) layer, and a media access control (Radio access Control, MAC) layer, and the SeNB includes an RLC layer and an MAC layer. In the network architecture, unlicensed spectrum cells may be deployed in the foregoing manner 1. For example, in cells of the MeNB, a cell filled with grids is a licensed spectrum cell, and a cell filled with vertical lines is an unlicensed spectrum cell. Unlicensed spectrum cells may alternatively be deployed in the foregoing manner 2. For example, all cells in the SeNB are unlicensed spectrum cells.

It should be noted that although in the MeNB in FIG. 1, licensed spectrum cells and unlicensed spectrum cells are deployed in a co-site manner, only unlicensed spectrum cells exist in the SeNB, and the MeNB and the SeNB are in a relationship of a master base station and a secondary base station. In fact, only unlicensed spectrum cells may exist in the MeNB, and in the SeNB, licensed spectrum cells and unlicensed spectrum cells are deployed in a co-site manner. In addition, the two base stations are deployed independently, and do not have a master-secondary relationship.

It should be noted that the uplink information transmission method provided in this embodiment of the present invention may be applied in a scenario of separate networking of unlicensed spectrum cells, may be applied to a scenario in which unlicensed spectrum cells and licensed spectrum cells are in a same network but the licensed spectrum cells are not relied on to transmit uplink information, and may further be further applied to a scenario in which unlicensed spectrum cells and licensed spectrum cells are in a same network but the licensed spectrum cells are only partly relied on to transmit uplink information. The following describes the method in the present invention in detail on a basis of FIG. 1. For details, refer to FIG. 2.

### Embodiment 1

FIG. 2 is a flowchart of Embodiment 1 of an uplink information transmission method according to the present invention. In this embodiment, a base station interacts with a terminal, and this embodiment is applicable to a scenario in which uplink information needs to be transmitted by using a cell group. Specifically, this embodiment includes the following steps:

101: A base station configures a cell group for user equipment.

In this step, the base station configures the cell group by selecting one or more cells from cells that provide an aggregation service for the user equipment. A quantity of cells in the cell group is less than or equal to a quantity of cells providing the aggregation service. The one or more cells in the cell group include licensed spectrum cells and/or unlicensed spectrum cells.

102: The base station sends configuration information to the UE, where the information indicates the cell group that is configured by the base station for the UE.

After configuring the cell group for the UE, the base station sends configuration information of the cell group to the UE, where the configuration information includes information such as which cells and which physical resource positions are included in the cell group, and in which subframes uplink information is transmitted.

103: The UE sends uplink information to the base station by using the cell group.

After receiving the configuration information, the UE sends the uplink information to the base station by using the cell group. For example, the UE sends uplink control information or uplink data information to the base station by using one or more unlicensed spectrum cells in the cell group. For example, when sending the uplink control information, a plurality of cells in a same cell group together perform a function of a physical uplink control channel (Physical Uplink Control Channel, PUCCH), that is, a function of uplink control information transmission. The uplink control information includes a channel state indication (Channel State indication, CSI), a rank indication (Rank Indication, RI), a precodin LT, matrix indicator (Precoding Matrix Indicator, PMI), a hybrid automatic repeat request (Hybrid Automatic Repeat reQuest, HARQ), and the like.

In addition, in the foregoing cell group configuration process, the base station may alternatively configure a cell group set for the user equipment and send configuration information of the cell group set to the UE. Each cell group in the cell group set includes one or more cells. After receiving the configuration information of the cell group set, the UE selects one cell group from the cell group set, that is, selects one or more cells from the cell group set, and sends uplink information to the base station by using the selected cell group. In this way, a plurality of cells in the same cell group collaboratively transmit uplink data information and uplink control information required for the uplink data information transmission. Cell groups work independently of each other.

According to the uplink information transmission method provided in this embodiment of the present invention, the base station configures the cell group for the UE, and sends the configuration information of the cell group to the UE, so that the UE sends the uplink information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

The following describes the uplink information transmission method in the present invention in detail by using different embodiments. For details, refer to the following Embodiments 2 to 11.

### Embodiment 2

In this embodiment, the uplink information includes uplink information of a first cell, and that the UE sends uplink information to the base station by using the cell group includes: the UE sends the uplink information of the first cell sent by using the first cell; or the UE sends the uplink information of the first cell by using a second cell. The first cell is a cell in the cell group, and the second cell is another cell different from the first cell in the cell group. To be specific, in a same reporting period, the uplink information of the first cell may be reported by using the first cell, or may be reported by using the second cell. For example, in a first reporting period, the uplink information of the first cell is reported by using the first cell, and in a second reporting period, the uplink information of the first cell is reported by using the second cell. In addition, when the second cell is an unlicensed spectrum cell, before the uplink information of the first cell is transmitted by using the second cell, it needs to be determined that the second cell is an available licensed spectrum cell.

Specifically, for example, the uplink information is specifically uplink control information, and it is assumed that the base station configures a cell group set for the UE. In this case, the cell group configuration obtained based on a cell group index is shown in Table 1.

TABLE 1

| | | |
|---|---|---|
| Cell group | Cell 1 | CSI occasion of a cell 1: |
| index | | a CQI period, an offset value, a cell X1 is used for |
| | | reporting, and a physical resource for reporting |
| | | an RI period, an offset value, a cell Y1 is used for |
| | | reporting, and a physical resource for reporting |
| | | a PMI period, an offset value, a cell Z1 is used for |
| | | reporting, and a physical resource for reporting |
| | | a PTI period, an offset value, a cell K1 is used for |
| | | reporting, and a physical resource for reporting |
| | | . . . |
| | Cell 2 | CSI occasion of a cell 2: |
| | | a CQI period, an offset value, a cell X2 is used for |
| | | reporting, and a physical resource for reporting |
| | | an RI period, an offset value, a cell Y2 is used for |
| | | reporting, and a physical resource for reporting |
| | | a PMI period, an offset value, a cell Z2 is used for |
| | | reporting, and a physical resource for reporting |
| | | a PTI period, an offset value, a cell K2 is used for |
| | | reporting, and a physical resource for reporting |
| | | . . . |
| | Cell 3 | CSI occasion of a cell 3: |
| | | a CQI period, an offset value, a cell X3 is used for |
| | | reporting, and a physical resource for reporting |
| | | an RI period, an offset value, a cell Y3 is used for |
| | | reporting, and a physical resource for reporting |
| | | a PMI period, an offset value, a cell Z3 is used for |
| | | reporting, and a physical resource for reporting |
| | | a PTI period, an offset value, a cell K3 is used for |
| | | reporting, and a physical resource for reporting |
| | | . . . |

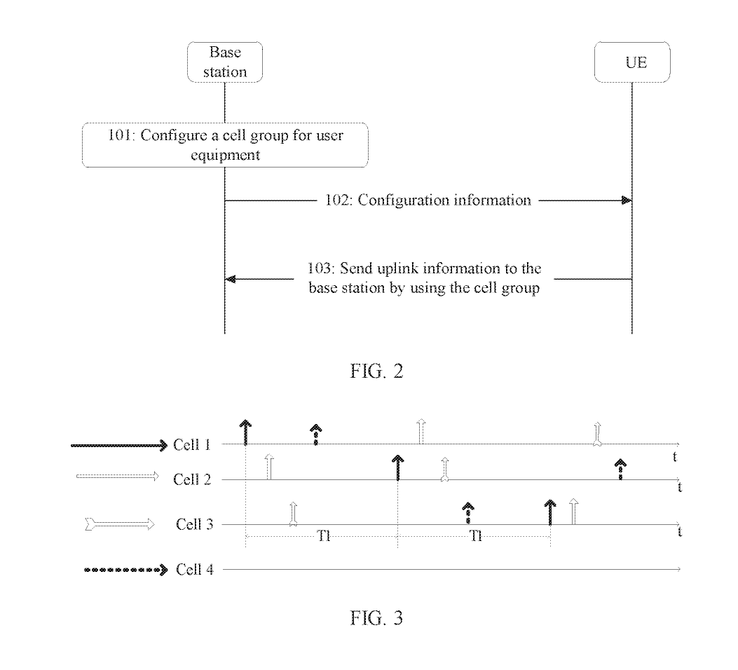

The following describes the uplink information transmission method in the present invention in detail by using an example in which uplink control information is specifically CQI. For details, refer to FIG. 3. FIG. 3 is a schematic diagram of a CQI reporting process in Embodiment 2 of an uplink information transmission method according to the present invention.

Referring to FIG. 3, it is assumed that a cell group includes four cells: a cell 1 to a cell 4. In the figure, a black solid-line arrow indicates a CQI reporting occasion of the cell 1, a hollow arrow without a tail indicates a CQI reporting occasion of the cell 2, a hollow arrow with a tail indicates a CQI reporting occasion of the cell 3, and a black dashed-line arrow indicates a CQI reporting occasion of the cell 4. Using CQI of the cell 1 as an example, the UE finds, based on a period and an offset in the configuration information shown in Table 1, a subframe that meets a condition that a CQI period T1 of a (SFN×10+subframe number) modCell1 is equal to a CQI offset value of the cell 1, and reports the CQI in a corresponding subframe by using a corresponding cell. The CQI is reported by using the cell 1 for a first time, reported by using the cell 2 for a second time, and reported by the cell 3 for a third time. For reporting of other uplink control information, such as an RI, a PMI, a HARQ, and a PTI, a mechanism is the same as a CQI reporting mechanism.

It should be noted that for the cell 4 in the cell group, corresponding uplink control information may all be transmitted by using another cell. The cell 4 is not used to transmit the uplink control information, for example, when the cell 4 is a cell that works only in downlink.

According to the uplink information transmission method provided in Embodiment 2 of the present invention, for a specific cell in the cell group, uplink information of the cell is distributed to the cell or another cell, so that uplink information of the entire cell group is distributed to a plurality of cells in the cell group, for transmission. This resolves a problem of a limited PCell capacity.

### Embodiment 3

In Embodiment 2, how to transmit the uplink information of the first cell when the second cell is an unlicensed spectrum cell and is unavailable is not described. In this embodiment, how to transmit the uplink information of the first cell when the second cell is an unlicensed spectrum cell and is unavailable is described in detail. The first cell may be a licensed spectrum cell, or may be an unlicensed spectrum cell.

In this embodiment, the second cell is an unlicensed spectrum cell. Before the UE sends the uplink information of the first cell to the base station by using the second cell, if it is determined that the second cell is an unavailable unlicensed spectrum cell at this moment, the following two types of processing are performed: Processing 1: The UE does not send the uplink information of the first cell; Processing 2: The UE starts a window timer at a time point at which the uplink information of the first cell should have been sent; detects, during running of the window timer, whether the second cell is available; and if the second cell is available, sends the uplink information of the first cell to the base station by using the second cell, or if the second cell is unavailable, does not send the uplink information of the first cell.

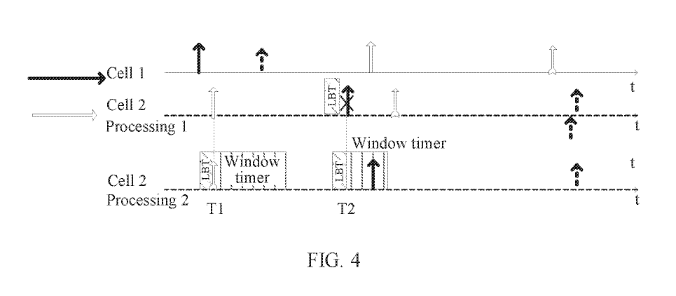

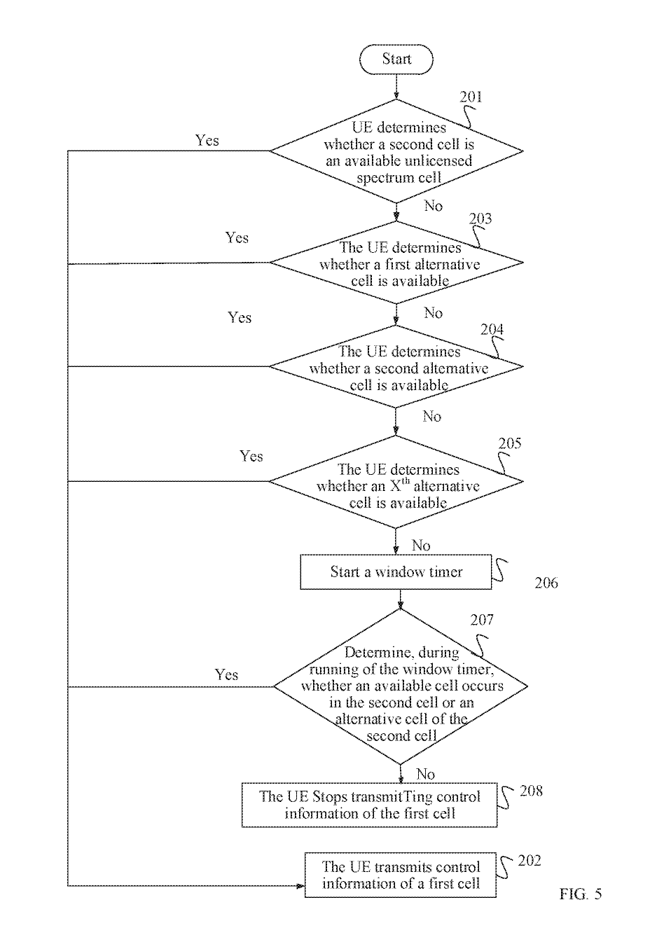

Specifically; when configuring a cell group for the UE, the base station indicates to the UE whether a type of each cell in the cell group is a licensed spectrum cell or an unlicensed spectrum cell. After the UE calculates an uplink information sending occasion, if the uplink information is transmitted in an unlicensed spectrum cell, the UE needs to perform listen before talk (Listen before talk, LBT) before transmitting the uplink information, that is, to monitor whether the unlicensed spectrum cell is available. If the unlicensed spectrum cell is currently occupied, transmission cannot be performed. In this case, the foregoing Processing 1 may be used. That is, when the LBT fails, the UE does not send the uplink information. Alternatively, the foregoing Processing 2 may be used. That is, when the LBT fails, the UE starts a window timer from a time point at which the uplink information should have been sent, and continues to perform the LBT on the second cell during running of the timer. If the LBT succeeds, the UE sends the uplink information at a success time point. If the LBT is always unsuccessful during running of the timer, the UE does not send the uplink information. For details, refer to FIG. 4.

FIG. 4 is a schematic diagram of repotting uplink information by using an unlicensed spectrum cell in Embodiment 3 of an uplink information transmission method according to the present invention.

Referring to FIG. 4, it is assumed that a cell 2 is an unlicensed spectrum cell. UE should have sent uplink information of a cell 1 at a time point T2 by using the cell 2, but LBT fails. According to Processing 1, the UE does not send the uplink information of the cell 1 at the time point T2 by using the cell 2; according to Processing 2, the UE starts a window timer at the time point T2, and continues to perform the LBT during running of the window timer. If the LBT is successful, the UE sends the uplink information of the cell 1 by using the cell 2.

It should be noted that when Processing 2 is used, in a same unlicensed spectrum cell, timing duration of a window timer used for sending uplink information of different cells may be the same or be different, and timing duration of a window timer used for transmitting different types of uplink information in a same cell may be the same or be different. In other words, from a perspective of UE, timing duration of a window timer configured for each UE may be different; from a perspective of a cell, timing duration of a window timer configured for each cell may be different; and for different types of uplink information, timing duration of a window timer configured for each type of uplink information may be different.

According to the uplink information transmission method provided in Embodiment 3 of the present invention, when uplink information is transmitted by using an unlicensed spectrum cell, when the unlicensed spectrum cell is detected to be unavailable, the transmission is stopped or a window timer is started. When the unlicensed spectrum cell is detected, in the window tinier, to be available, the uplink information transmission continues. Therefore, reliability of uplink information transmission by using an unlicensed spectrum cell is improved.

### Embodiment 4

In Embodiment 3, at an uplink information sending occasion, when a second cell is detected to be an unavailable unlicensed spectrum cell, either uplink information transmission is stopped or a window timer is started. When the second cell is detected, during running of the window timer, to be available, uplink information of a first cell continues to be sent by using the second cell. In this process, a same unlicensed spectrum cell is used for uplink information transmission. In this embodiment, the second cell is an unlicensed spectrum cell. Before sending the uplink information of the first cell to the base station by using the second cell, if it is determined that the second cell is an unavailable unlicensed spectrum cell, the UE determines whether there is an available alternative cell in at least one alternative cell of the second cell. If the UE determines that there is an available alternative cell in the at least one alternative cell of the second cell, the UE sends the uplink information of the first cell to the base station by using the available alternative cell of the second cell; or if there is no available alternative cell in the at least one alternative cell of the second cell, the UE stops sending the uplink information of the first cell to the base station by using the second cell.

Specifically, for each unlicensed spectrum cell, the base station configures one or more alternative cells for the unlicensed spectrum cell. If a plurality of alternative cells are configured, a sequence of the alternative cells is simultaneously configured. Alternatively, the sequence may not be configured. In this case, the UE determines the sequence. Before transmitting uplink information, if the UE fails in performing LBT on an unlicensed spectrum cell, the UE selects an alternative cell based on the sequence, and transmits the uplink information by using the alternative cell. In this process, if all alternative cells are unlicensed spectrum cells, and all the alternative cells are unavailable at a current time point, the UE starts a window timer, and monitors the alternative cells during running of the window timer. When a spectrum of an alternative cell first changes to be available, the alternative cell is used for the uplink information transmission. If the window timer expires, and all the alternative cells are always in an unavailable state, the UE abandons sending the uplink information. For details, refer to FIG. 5.

FIG. 5 is a flowchart of reporting uplink information by using an alternative cell of an unlicensed spectrum cell in Embodiment 4 of the uplink information transmission method according to the present invention, including the following steps.

201: UE determines whether a second cell is an available unlicensed spectrum cell.

In this step, the second cell is an unlicensed spectrum cell. The UE detects whether the second cell is available at a time point of sending uplink information. If the second cell is available, step 202 is performed; or if the second cell is unavailable, step 203 is performed.

202: The UE transmits uplink information of a first cell.

In this step, the UE sends the uplink information of the first cell by using the second cell.

203: The UE determines whether a first alternative cell is available. If the first alternative cell is available, step 202 is performed; if the first alternative cell is unavailable, step 204 is performed.

Step 204: The UE determines whether a second alternative cell is available. If the second alternative cell is available, step 202 is performed; if the second alternative cell is unavailable, step 205 is performed. Determining is sequentially performed on other alternative cells.

Step 205: The UE determines whether an X^{th} alternative cell is available. If the X^{th} alternative cell is available, step 202 is performed; if the X^{th} alternative cell is unavailable, step 206 is performed.

Step 206: Start a window timer.

207: Determine, during running of the window tinier, whether an available cell occurs in the second cell or an alternative cell of the second cell. If an available cell occurs in the second cell or the alternative cell of the second cell, step 202 is performed; if no available cell occurs in the second cell or the alternative cell of the second cell, step 208 is performed.

208: The UE stops transmitting the uplink information.

It should be noted that steps 206 and 207 in FIG. 5 are optional steps.

It should be noted that in a same unlicensed spectrum cell, alternative cells used for sending uplink information of different cells may be the same or be different, and alternative cells used for transmitting different types of uplink information of a same cell may be the same or be different. In other words, from a perspective of UE, an alternative cell configured for each UE may be different; from a perspective of a cell, an alternative cell configured for each cell may be different; and for different types of uplink information, an alternative cell configured for each type of uplink information may be different.

In addition, when the UE transmits the uplink information by using an alternative cell, a time-frequency resource position used in the alternative cell may be the same as or be different from a time-frequency resource position used in the second cell. When the time-frequency resource position used in the alternative cell is different from the time-frequency resource position used in the second cell, the time-frequency resource position of the alternative cell may be allocated by a base station, or may be deduced by the UE based on a time-frequency resource position that is in the second cell and that is allocated to the UE.

According to the uplink information transmission method provided in Embodiment 4 of the present invention, a plurality of alternative cells are configured for an unlicensed spectrum cell, to improve reliability of uplink information transmission.

### Embodiment 5

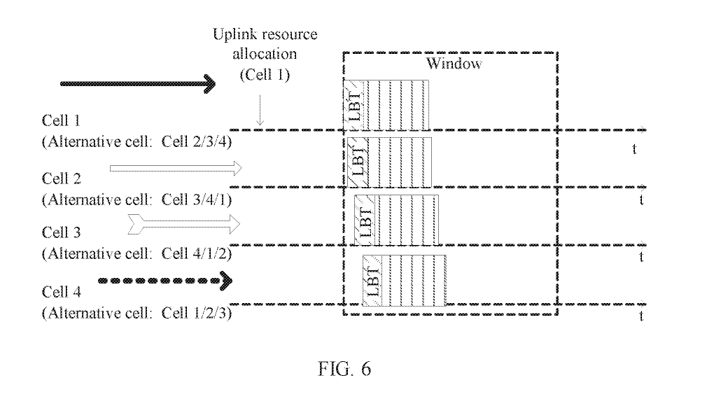

In addition to being applicable to transmission of uplink control information in uplink information, the solutions described in Embodiments 1 to 4 are also applicable to transmission of uplink data information in the uplink information. The following describes the uplink data information transmission in detail by using FIG. 6 as an example.

FIG. 6 is a schematic diagram of sending uplink data information in an uplink information transmission method according to the present invention. Referring to FIG. 6, it is assumed that a cell group includes four cells: a cell 1 to a cell 4. The cells are all unlicensed spectrum cells. Based on a priority sequence, alternative cells of the cell 1 are sequentially a cell 2, a cell 3, and the cell 4; alternative cells of the cell 2 are sequentially the cell 3, the cell 4, and the cell 1; alternative cells of the cell 3 are sequentially the cell 4, the cell 1, and the cell 2; and alternative cells of the cell 4 are sequentially the cell 1, the cell 2, and the cell 3. In an uplink data information transmission process, assuming that UE determines, based on uplink resource indication information, that a target cell is the cell 1, if the cell 1 is unavailable at an uplink transmission occasion, the UE performs LBT sequentially on the cell 2, the cell 3, and the cell 4, and transmits uplink data information in an available cell. It should be noted that in FIG. 6, to emphasize a behavior of performing LBT sequentially by the UE, each LBT is apparently staggered from another in time. However, actually, compared with a subframe length, LBT duration is especially short. Information about an alternative cell may be configured by a base station by using RRC signaling, or may be temporarily indicated by the base station to the UE when indicating an uplink resource. This is not limited in the present invention.

In the foregoing process, when the base station allocates an uplink resource to the UE, information indicated by uplink resource indication information may merely indicate a cell in which the uplink resource is located, a location of a physical resource block (Physical Resource Block, PRB), a modulation and coding scheme (Modulation and Coding Scheme, MCS), whether CSI information is carried, transmission power control (Transport Power Control, TPC), or the like, and may further indicate, to each alternative cell, different uplink resource allocation parameters. The base station may even preconfigure, by using high layer signaling, uplink resource allocation parameters used for each alternative cell. This is not limited in this embodiment of the present invention.

In Embodiment 5 of the present invention, a plurality of alternative cells are configured for an unlicensed spectrum cell, to improve reliability of uplink data information transmission.

### Embodiment 6

In this embodiment, UE determines a radio link monitoring RLM group from the cell group, where cells in the RLM group are all unlicensed spectrum cells. The UE sequentially performs RLM on the cells in the RLM cell group, determines, based on the RLM, that the cells in the RLM cell group are all unavailable, starts an RLM timer, and detects, during running of the RLM timer, whether there is an available unlicensed spectrum cell in the RLM cell group. If there is an available unlicensed spectrum cell in the RLM cell group, the UE stops the RLM timer, or if there is no available unlicensed spectrum cell in the RLM cell group, the UE determines, after the RLM timer expires, that a radio link failure RLF occurs in all unlicensed spectrum cells in the RLM cell group. That the UE sequentially performs RLM on the cells in the RLM cell group means that within a large-scale time, the UE performs RLM on each cell in the RLM cell group, but does not simultaneously perform RLM on a plurality of cells.

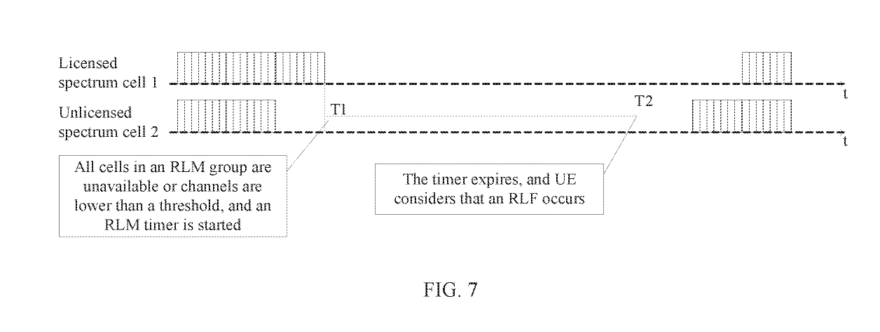

Specifically, an eNB configures a radio link monitoring (Radio Link Monitor, RLM) group for the UE, and sends configuration information of the RLM group to the UE. After determining the RLM group, the UE performs RLM within the RLM group. If a cell in which the UE is currently performing RLM becomes unavailable, the UE selects another available cell to perform RLM. Alternatively, the eNB configures a cell priority, and if a cell in which the UE is currently performing RLM becomes unavailable, the UE selects one cell with a highest priority from currently available cells, as a new RLM target. When all cells in the RLM group are unavailable, or channels of all of the cells are lower than a threshold, the UE starts an RLM timer. The UE stops running the RLM timer provided that during running of the RLM timer, one cell in the RLM group is detected to be available or a channel is higher than the threshold. If the RLM timer expires, the UE considers that a radio link failure (Radio Link failure, RLF) occurs. In this case, the UE reports the RLF by using another cell, or initiates radio resource control (Radio Resource Control, RRC) reestablishment. For details, refer to FIG. 7.

FIG. 7 is a schematic diagram of monitoring RLM by UE by using an RLM cell group in an uplink information transmission method according to the present invention. Referring to FIG. 7, an RLM group includes two cells: an unlicensed spectrum cell 1 and an unlicensed spectrum cell 2. At a time point T1, the UE detects that both the unlicensed spectrum cell 1 and the unlicensed spectrum cell are unavailable, or channels are lower than a threshold, and the UE starts an RLM timer. The UE continues to detect, during running of the RLM timer, whether the unlicensed spectrum cell 1 and the unlicensed spectrum cell 2 are available. If the unlicensed spectrum cell 1 and the unlicensed spectrum cell 2 are available, the UE stops running the RLM timer; or if the unlicensed spectrum cell 1 and the unlicensed spectrum cell 2 are unavailable, the UE determines, after the RLM timer expires, that is, at a time point T2, that an RLF occurs in all unlicensed spectrum cells in the RLM cell group.

In Embodiment 6 of the present invention, detection is performed on radio signals of a plurality of cells in the RLM group; it is considered that the RLF occurs, only when signals of all cells are unavailable and such a situation has lasted for a period of time. This increases an RLF determining threshold, improves availability of unlicensed spectrum cells, and resolves a problem of RLM misdetermining caused by unavailability of the unlicensed spectrum cells.

### Embodiment 7

In this embodiment, UE determines an uplink time reference group from a cell group, where cells in the uplink time reference group are all unlicensed spectrum cells. The UE determines whether there is an available unlicensed spectrum cell in the uplink time reference group; and if there is an available unlicensed spectrum cell in the uplink time reference group, selects one from the available unlicensed spectrum cell as an uplink time reference; or if there is no available unlicensed spectrum cell in the uplink reference time group, starts an uplink transmit timer, detects, during running of the uplink transmit timer, whether there is an available unlicensed spectrum cell in the uplink time reference group, and if there is an available unlicensed spectrum cell in the uplink time reference group, stops the uplink transmit timer, or if there is no available unlicensed spectrum cell in the uplink time reference group, determines, after the uplink transmit timer expires, that the UE and the base station are asynchronous.

Specifically, an eNB configures an uplink time reference group for the UE, and sends configuration information of the uplink time reference group to the UE. After determining the uplink time reference group, the UE selects an available cell from the uplink time reference group as an uplink time reference. If cells in the uplink time reference group are all unavailable, the UE starts an uplink transmit timer, and stops the uplink transmit timer provided that any cell in the uplink time reference group becomes available before the uplink timer expires, and uses the available cell as an uplink time reference cell. During running of the timer, if the UE needs to send uplink information, for example, uplink control information or uplink data information, the UE uses an internally maintained clock of the UE as the uplink time reference. If the timer expires and all cells are unavailable, the UE considers that the internally maintained clock of the UE is no longer synchronous with a base-station clock, and the UE initiates sending of the uplink information.

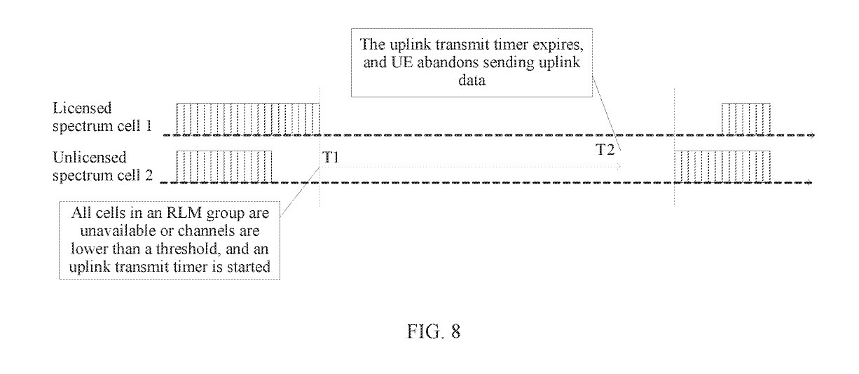

In the foregoing process, when sending the uplink information, the UE uses a downlink subframe of any cell in the uplink time reference group as a time reference. If all the cells in the cell group are currently unavailable, and the uplink transmit timer has not expired, the UE uses the internally maintained clock of the UE as the uplink time reference; of if all the cells in the uplink time reference group are currently unavailable, and the uplink transmit tinier has expired, the UE considers that the UE and the base station are asynchronous, and abandons uplink transmission. For details, refer to FIG. 8.

FIG. 8 is a schematic diagram of using, by UE, an unlicensed spectrum cell as an uplink time reference in an uplink information transmission method according to the present invention. Referring to FIG. 8, an uplink time reference group includes two cells: an unlicensed spectrum cell 1 and an unlicensed spectrum cell 2. Before a time point T1, there is an available unlicensed spectrum cell in the uplink time reference group. When sending uplink information, the UE selects any available unlicensed spectrum cell as the uplink time reference. At the time point T1, the UE detects that both the unlicensed spectrum cell 1 and the unlicensed spectrum cell are unavailable, or channels are lower than a threshold, and the UE starts an uplink transmit timer. During running of the uplink transmit timer, the UE uses an internally maintained clock of the UE as the uplink time reference, and if any unlicensed spectrum cell is detected to be available, uses the unlicensed spectrum cell as the uplink time reference. At a time point T2, the uplink transmit timer expires. In this case, the UE considers that the UE and a base station are asynchronous, and abandons sending the uplink information.

The UE continues to detect whether the unlicensed spectrum cell 1 and the unlicensed spectrum cell 2 are available, and if the unlicensed spectrum cell 1 and the unlicensed spectrum cell 2 are available, stops running the timer; or if the unlicensed spectrum cell 1 and the unlicensed spectrum cell 2 are unavailable, the UE determines, after the timer expires, that is, at the time point T2, that an RLF occurs in all unlicensed spectrum cells in the cell group.

In this embodiment, when all cells in the uplink time reference group are unavailable and after the timer expires, the UE determines that the UE and the base station are asynchronous, and further abandons sending the uplink information. This resolves a problem that the UE sends the uplink time reference because of unavailability of the unlicensed spectrum cells.

### Embodiment 8

In Embodiment 7, if all cells in the uplink time reference group are unavailable, and the uplink transmit timer expires, the UE abandons uplink sending. In this embodiment, the uplink time reference group further includes a licensed spectrum cell. When all unlicensed spectrum cells in the uplink time reference group are currently unavailable, and the uplink transmit timer expires, the UE receives a time difference sent by a base station, where the time difference indicates a subframe boundary difference between the licensed spectrum cell and each unlicensed spectrum cell in the uplink time reference group. The UE determines, after the uplink transmit timer expires, that the UE and the base station are asynchronous, and further determines an uplink transmit time reference based on the licensed spectrum cell and the time difference.

Specifically, an eNB pre-notifies a time difference to the UE, and the tune difference indicates a subframe boundary difference between the licensed spectrum cell and an unlicensed spectrum cell that are used by the UE. The eNB may notify the time difference to the UE by using RRC signaling or MAC signaling, and may further update the time difference periodically or trigger, based on an event, updating of the time difference. For example, if the UE detects that a tune difference is greater than the value notified by the eNB, the UE informs the eNB. After receiving the notification, the eNB sends an updated time difference value. When all unlicensed cells in the uplink time reference cell group are currently unavailable, and the uplink transmit timer expires, the UE uses the licensed spectrum cell as the time reference, and uses the “time difference” together with a downlink subframe boundary of the licensed spectrum cell as the uplink transmit time reference. For details, refer to FIG. 9.

FIG. 9 is a schematic diagram of determining, by UE, an uplink time reference by using a licensed spectrum cell and a time difference, in an uplink information transmission method according to the present invention. Referring to FIG. 9, at a time point T2, when all unlicensed cells in an uplink time reference cell group are currently unavailable, and an uplink transmit timer expires, the UE uses the licensed spectrum cell as the time reference, and uses the “time difference” together with a downlink subframe boundary of the licensed spectrum cell as the uplink transmit time reference.

In this embodiment, the uplink time reference group further includes the licensed spectrum cell. When all cells in the uplink time reference group are unavailable and the timer expires, the UE uses the licensed spectrum cell as the time reference, and uses the “time difference” together with the downlink subframe boundary of the licensed spectrum cell as the uplink transmit time reference. This resolves a problem that the UE sends the uplink time reference because of unavailability of the unlicensed spectrum cells.

### Embodiment 9

In this embodiment, the UE determines, based on a Single Cell Point To Multipoint SC-PTM priority, a third cell from a cell group, where the third cell is a cell with a highest SC-PTM priority in the cell group, or the third cell is a cell with a lowest SC-PTM priority in the cell group; and receives, in one multicast control channel MCCH period by using the third cell, a single cell multicast control channel SC-MCCH message sent by the base station.

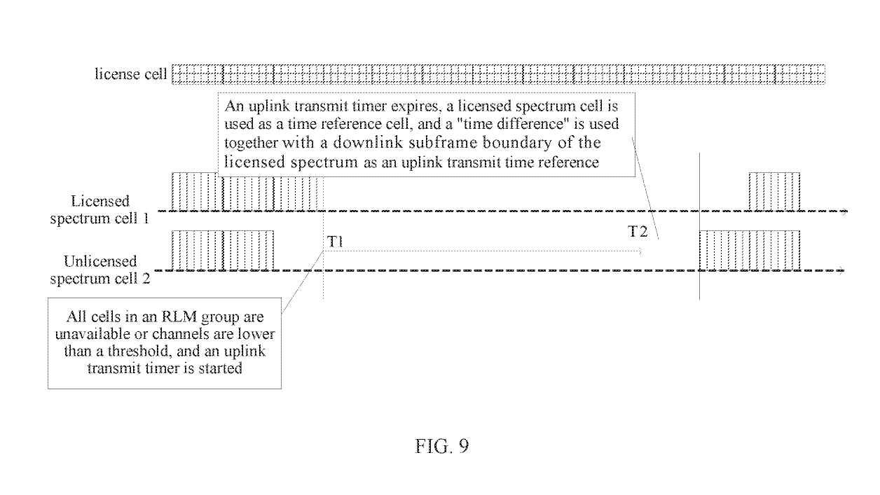

Specifically, the base station configures the cell group for the UE. Broadcast information of all cells in the cell group may be notified by the base station to the UE by using dedicated signaling, or may be notified by the base station to the UE by using broadcast signaling. The broadcast information of all the cells in the cell group includes Single Cell Point To Multipoint (Single Cell Point To Multipoint SC-PTM, SC-PTM) transmission related parameters: information such as a repeat period, an offset value, and a subframe number of the SC-MCCH. In addition, content of SC-MCCH messages of all the cells in the cell group are identical. In other words, all the cells in the cell group use a same radio frame number and a same subframe number, and send SC-MCCH messages in a same subframe. Certainly, when an unlicensed spectrum cell is used to send an SC-MCCH message, a right to use a spectrum needs to be obtained first. Compared to a licensed spectrum cell, an unlicensed spectrum cell further needs to notify an SC-PTM priority of the cell in the cell group to the UE. In this case, if a plurality of unlicensed spectrum cells obtain the right to use the spectrum at a same time point, the base station sends the SC-MCCH message only by using an unlicensed spectrum cell with a highest priority, instead of sending the SC-MCCH by using an other unlicensed spectrum cell. Certainly, the SC-MCCH message may be alternatively sent by using only an unlicensed spectrum cell with a lowest priority. For details, refer to FIG. 10.

{FIG. 10 is a schematic diagram of sending an SC-MCCH in an uplink information transmission method according to the present invention. Referring to FIG. 10, a cell group includes three unlicensed spectrum cells: a cell 1 to a cell 3, priorities of which decrease sequentially. After reading system information of the unlicensed spectrum cells. UE determines subframes in which a base station sends an SC-MCCH message by using the cell group. FIG. 10 shows two occasions of sending the SC-MCCH message. In a first occasion, both the cell 1 and a cell 2 obtains a spectrum use right, and in the two cells, the cell 1 has a higher priority. Therefore, the base station sends the SC-MCCH message by using the cell 1. In a second occasion, only the cell 3 obtains the spectrum use right. Therefore, the base station sends the SC-MCCH message by using the cell 3. Certainly, it is possible that no cell obtains the spectrum use right in the occasions of sending the SC-MCCH. In this case, the base station does not send the SC-MCCH message. After receiving the SC-MCCH sent by the base station, the UE determines, based on the SC-MCCH, an SC-MTCH window for sending the SC-MTCH message by the base station, including a start position and a window length of the SC-MTCH window The UE determines, based on the SC-PTM priority, a fourth cell from the cell group, where the fourth cell is an unlicensed spectrum cell that is available in a time corresponding to the SC-MTCH window The UE receives, by using the fourth cell, the SC-MTCH message sent by the base station in the SC-MTCH window.

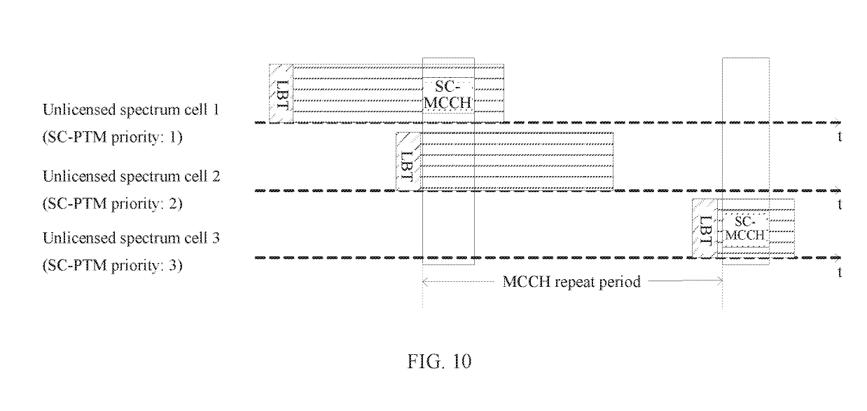

Specifically, for an SC-MCCH of the UE, the UE determines a sending occasion for sending the single cell multicast traffic channel (Multicast Traffic Channel, SC-MTCH) message by the base station. The sending occasion may be understood as which window and which radio network temporary identity (Radio Network Temporary Identity, RNTI) are used for sending. For details, refer to FIG. 11.

FIG. 11 is a schematic diagram of sending an SC-MTCH message in an uplink information transmission method according to the present invention. Referring to FIG. 11, a base station negotiates, in an SC-MCCH, with UE about a start position and a window length of a window for sending the SC-MTCH message. The start position of the window may be represented by a scheduling period start offset SCPTM, and the window length is represented by an on duration timer SCPTM. Referring to FIG. 11, in a first SC-PTM period, both a cell 1 and a cell 2 obtains a spectrum use right, and the base station sends an SC-MTCH by using the cell 1 with a highest SC-PTM priority, as shown by a thick black line in the figure. After sending the SC-MTCH, the base station starts a discontinuous reception (Discontinuous Reception, DRX) inactivity tinier SCPTM (DRX-Inactivity Timer SCPTM), and extends the sending window to T3. However, a sending occasion of the cell 1 can lasts only to T2. From time points T2 to T3, only the cell 2 in the cell group has the spectrum use right. In this case, if the base station still has an SC-MTCH to send, the base station sends the SC-MTCH by using the cell 2. At the time point T3, the DRX-Inactivity Timer SCPTM expires, the window ends, and the base station stops sending the SC-MTCH.

In a second SC-PTM period, a sending occasion of the SC-MTCH is 14. In this case, the start position of the window is 14, and within the window length, only the cell 3 obtains the spectrum use right. Therefore, the base station sends the SC-MTCH by using the cell 3.

It should be noted that if within the window length, the base station does not need to send an SC-MTCH, the base station waits until the window ends after the window duration. Certainly, it is possible that no cell obtains the spectrum use right in the window length. In this case, the base station does not send the SC-MTCH.

In this embodiment, a plurality of unlicensed spectrum cells are bound together to collaboratively send an SC-MCCH or an SC-MTCH, thereby improving a success rate of sending.

### Embodiment 10

In this embodiment, UE receives, by using a fifth cell in a cell group, downlink data sent by a base station, where the fifth cell is an unlicensed spectrum cell; and determines a sixth cell from the cell group, where the sixth group is a cell that occurs earliest within a hybrid automatic repeat request window HARQ windows time of the downlink data and that has an available physical uplink shared channel PUCCH opportunity. That the UE sends uplink information to the base station by using the cell group includes: sending, by the UE, a HARQ of the downlink data to the base station by using the PUCCH opportunity of the sixth cell.

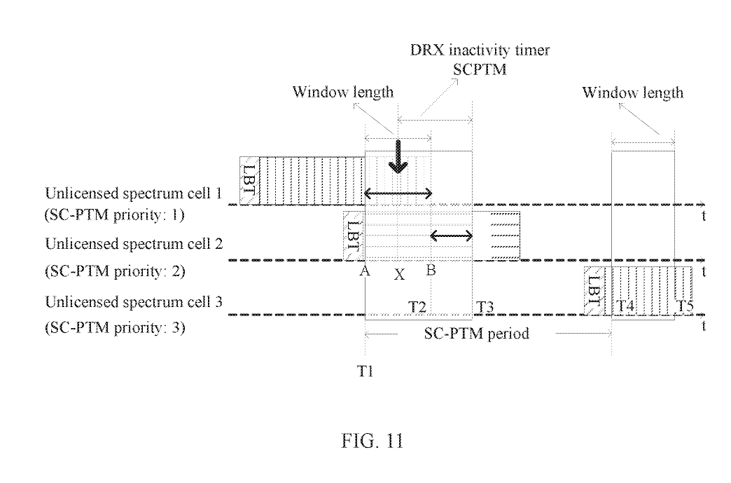

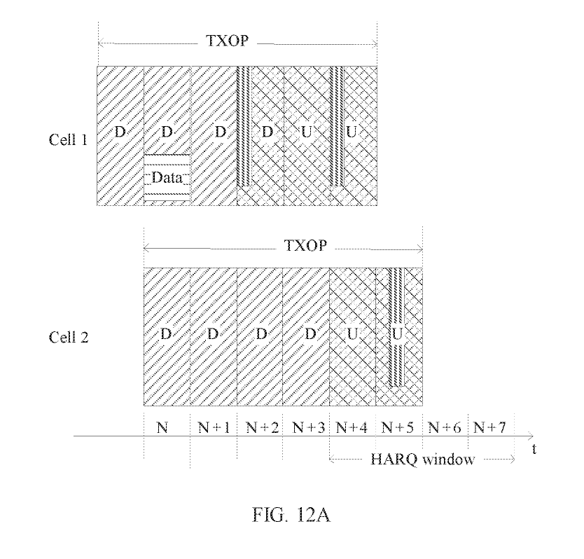

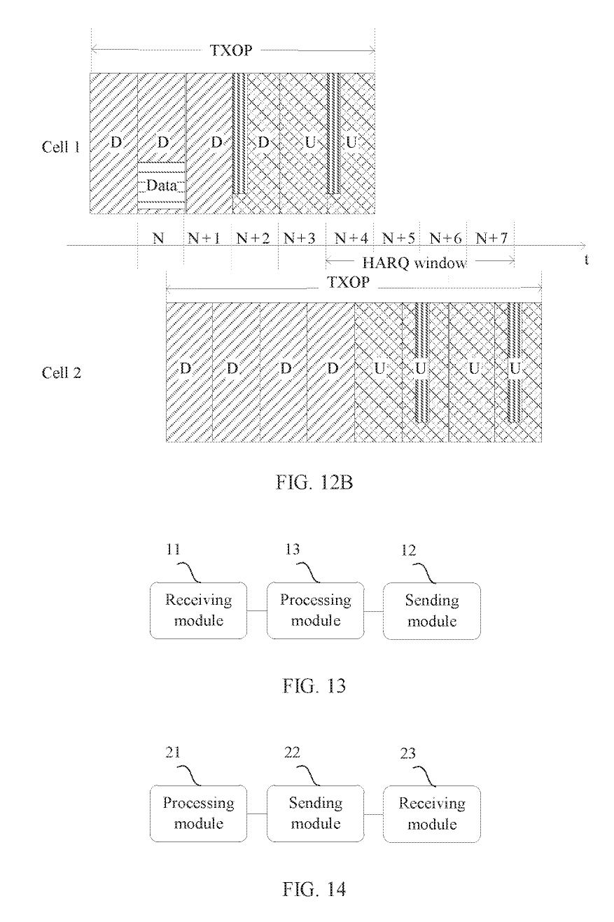

Specifically, when cells of the cell group are synchronous, the base station preconfigures an uplink-downlink subframe configuration for each cell. In some uplink subframes, a PUCCH may be configured depending on a requirement, and a time-frequency position of the PUCCH may be preconfigured and notified to the UE, as shown in FIG. 12A.

FIG. 12A shows a PUCCH when cells are synchronous according to an uplink information transmission method of the present invention. Referring to FIG. 12A, within one transmission opportunity (Transmission Opportunity, TXOP), at each time when a cell 1 preempts a spectrum, the cell 1 first sends three downlink subframes (parts filled with slashed lines shown in the figure), and then sends three uplink subframes (parts filled with grids shown in the figure), in a fixed manner. In the three uplink subframes, a first and a third subframes have time-frequency resources of the PUCCH, are located at a first column of symbols of the uplink subframes in time domain, and are located between an X^{th} physical resource element (Physical Resource Element, PRE) and a Y^{th} PRE in frequency domain (parts filled with vertical lines shown in the figure). At each time when a cell 2 preempts a spectrum, the cell 2 first sends four downlink subframes, and then sends two uplink subframes, in a fixed manner. In the two uplink subframes, a second uplink subframe has time-frequency resources of the PUCCH, is located at a second column of symbols in time domain, and is located at the X^{th} PRE and the Y^{th} PRE in frequency domain.

In a HARQ feedback process, the UE receives downlink data from an unlicensed spectrum cell, and selects a PUCCH opportunity that occurs earliest in a time window, to transmit a HARQ feedback. Certainly, before transmitting the HARQ feedback, the UE needs to perform channel monitoring and preempt a spectrum use right. If it is found that a corresponding spectrum has been occupied, the HARQ feedback cannot be performed at a sending occasion of the PUCCH. In this case, the UE needs to select a next PUCCH opportunity in the window, and attempt to transmit the HARQ feedback again. Referring to FIG. 12A, an eNB sends a data block (a part filled with horizontal lines shown in the figure) to the UE in a subframe N by using the cell 1. It is assumed that the UE considers that the HARQ windows (HARQ windows) start from a subframe N+4 and ends at N+7. The UE sends the HARQ feedback in a PUCCH resource that occurs the earliest, that is, a PUCCH resource in the subframe N+4 and the cell 1 to send the HARQ feedback. If the UE performs channel monitoring and finds that the resource has been occupied, the UE selects a PUCCH resource in a subframe N+5 and the cell 2 to send the HARQ feedback. If, at an end of the HARQ window, the UE still has not preempt a PUCCH use right, the UE does not send the HARQ feedback.

In the foregoing procedure, it is assumed that a plurality of unlicensed spectrum cells are synchronous. In other words, from a perspective of UE, subframe boundaries of the plurality of unlicensed spectrum cells are aligned. For an asynchronous scenario, the HARQ feedback procedure varies slightly. For details, refer to FIG. 12B.

FIG. 12B shows a PUCCH when cells are asynchronous according to an uplink information transmission method of the present invention. Referring to FIG. 12B, after receiving uplink data information in a cell 1, UE calculates a scale of a HARQ Window based on a subframe boundary of a cell, and determines, by using the scale, whether a PUCCH opportunity of a cell 2 fails within the HARQ windows. If a physical resource in which a PUCCH resource of the cell 2 is located crosses a boundary of the HARQ window in time, whether the PUCCH resource is applicable for sending the HARQ feedback depends on an eNB configuration.

It should be noted that in FIG. 12A and FIG. 12B, it is assumed an uplink-downlink subframe configuration after each time when an unlicensed spectrum cell preempts a spectrum use right is preconfigured, and does not dynamically change. Actually, the uplink-downlink subframe configuration may alternatively not be preconfigured, and is determined temporarily by the eNB based on a current uplink/downlink data amount after preempting a channel. The UE can deduce available PUCCH resources in the HARQ Window provided that notifies the UE is notified after the eNB determines the uplink-downlink subframe configuration for the TXOP.

In addition, it should be noted that both FIG. 12A and FIG. 12B do not consider a circumstance in which PUCCH resources of a plurality of cells occur at a same time. In such a circumstance, if the UE preempts a channel use right in one cell only, the UE uses a PUCCH of the cell for sending a HARQ; and if the UE simultaneously preempts a channel use right in a plurality of cells, the UE selects a cell based on a predefined sequence, and uses a PUCCH in the cell for sending the HARQ.

In this embodiment, the UE can send the HARQ by selecting one cell from the cell group. Compared with the prior-art practice of sending the HARQ only by using the PUCCH of the PCell, this improves a probability of feeding back the HARQ by the UE.

### Embodiment 11

In this embodiment, before sending control information to a base station by using a cell group, UE further determines a channel state indication CSI resource.

Specifically, the base station configures a periodic CSI resource for the UE, and configures a time position only, instead of configuring a specific cell. In this case, there are two implementation manners: Manner 1: The UE receives first CSI resource indication information sent by the base station, where the first CSI resource indication information indicates a time position of the CSI resource; and the UE reserves, based on the first CSI resource indication information, a time position in each cell of the cell group as a position of the CSI resource. Specifically, the base station reserves a PUCCH position for a time domain position of each unlicensed spectrum cell, and when the UE sends a PUSCH for rate matching (rate matching), the position is eschewed.

Manner 2: The UE receives second CSI resource indication information sent by the base station, where the second CSI resource indication information indicates a time position of the CSI resource and a seventh cell; and the UE reserves, based on the second CSI resource indication information, a time position in the seventh cell as a position of the CSI resource. Specifically, at a start of each TXOP, the base station notifies in which unlicensed spectrum cell the PUCCH is located through broadcasting, and an unlicensed cell without a PUCCH uses a corresponding position as the PUSCH.

The UE determines, at a preconfigured periodic CSI resource position, which unlicensed spectrum cells are uplink subframes, performs channel monitoring in the cells and preempts a spectrum use right. If the successfully obtains a use right of an unlicensed spectrum cell and there is no PUSCH for sending, the UE uses a PUCCH of an unlicensed spectrum cell whose spectrum is preempted for sending uplink control information such as CSI. If UE determines, at a preconfigured periodic CSI resource position, which unlicensed spectrum cells are uplink subframes, performs channel monitoring in the cells and preempts a spectrum use right. If the UE preempts a spectrum and there is a PUSCH for sending, the UE uses a PUSCH of the unlicensed spectrum cell whose spectrum is preempted for sending the CSI. If the UE does not preempt a spectrum use right of any cell, the UE does not send CSI.

In addition, the foregoing processing may be changed to be based on a window mechanism. Specifically, periodic CSI is preconfigured for the UE, and the CSI resources are sorted based on a time window. Within each time window, there may be one or more PUCCH resources used for sending the periodic CSI, and the UE needs only to send the periodic CSI once. Based on a time sequence, the UE preempts a spectrum resource before preparing to send the periodic CSI. If the UE successfully preempts a spectrum resource, the UE use the PUCCH resource for sending the periodic CSI; if the UE is successful in preempting a spectrum resource, the UE does not send the periodic CSI, and preempts a spectrum resource before a next PUCCH resource in the window occurs. If the UE knows that the window ends but does not preempt a spectrum resource, the UE does not send the periodic CSI.

FIG. 13 is a schematic structural diagram of Embodiment 1 of user equipment according to the present invention. The user equipment provided in this embodiment may implement the steps of the method that is applied to user equipment and that is provided in any one of the embodiments of the present invention. Specifically, the user equipment provided in this embodiment includes:

a receiving module 11, configured to receive configuration information sent by a base station, where the configuration information indicates a cell group configured for the UE by the base station: and

a sending module 12, configured to send uplink information to the base station by using the cell group.

The user equipment provided in this embodiment of the present invention receives the configuration information of the cell group that is sent by the base station, and sends the uplink information based on the configuration information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

Optionally, in an embodiment of the present invention, the uplink information includes uplink information of a first cell; and

the sending module 12 is specifically configured to send the uplink information of the first cell to the base station by using the first cell;

or,

the sending module 12 is specifically configured to send the uplink information of the first cell to the base station by using a second cell; where

the first cell is a cell in the cell group, and the second cell is another cell different from the first cell in the cell group.

Optionally, in an embodiment of the present invention, the second cell is an unlicensed spectrum cell; and

the user equipment further includes:

a processing module 13, configured to determine, before the sending module 12 sends the uplink information of the first cell to the base station by using the second cell, that the second cell is an available unlicensed spectrum cell.

Optionally, in an embodiment of the present invention, the second cell is an unlicensed spectrum cell; and

the user equipment further includes:

a processing module 13, configured to determine, before the sending module 12 sends the uplink information of the first cell to the base station by using the second cell, that the second cell is an unavailable unlicensed spectrum cell.

Optionally, in an embodiment of the present invention, the sending module 12 is configured to send the uplink information of the first cell to the base station by using the second cell when the processing module 13 detects, during running of a window timer that is started at a time point of sending the uplink information of the first cell, that the second cell is available.

Optionally, in an embodiment of the present invention, the sending module 12 is configured to send, when the processing module 13 determines that there is an available alternative cell in at least one alternative cell of the second cell, the uplink information of the first cell to the base station by using the available alternative cell of the second cell.

Optionally, in an embodiment of the present invention, the processing module 13 is further configured to: determine a radio link monitoring RLM group, sequentially perform RLM on cells in the RLM cell group, determine, based on the RLM, that the cells in the RLM group are all unavailable, start an RLM timer, detect, during running of the RLM timer, whether there is an available unlicensed spectrum cell in the RLM cell group; and stop the RLM timer if there is an available unlicensed spectrum cell in the RLM cell group; or if there is no available unlicensed spectrum cell in the RLM cell group, determine, after the RLM timer expires, that a radio link failure RLF occurs in all unlicensed spectrum cells in the RLM cell group.

Optionally, in an embodiment of the present invention, the processing module 13 is further configured to: determine an uplink time reference group; determine whether there is an available unlicensed spectrum cell in the uplink time reference group, and if there is an available unlicensed spectrum cell in the uplink time reference group, select one from the available unlicensed spectrum cell as an uplink time reference; or if there is no available unlicensed spectrum cell in the uplink time reference group, start an uplink transmit timer, and detect, during running of the uplink transmit tinier, whether there is an available unlicensed spectrum cell in the uplink time reference group; and if there is an available unlicensed spectrum cell in the uplink time reference group, stop the uplink transmit timer, or if there is no available unlicensed spectrum cell in the uplink time reference group, determine, after the uplink transmit timer expires, that the UE and the base station are asynchronous.

Optionally, in an embodiment of the present invention, the uplink time reference group further includes a licensed spectrum cell, and the receiving module 11 is further configured to receive a time difference sent by the base station, where the time difference indicates a subframe boundary difference between the licensed spectrum cell and each unlicensed spectrum cell in the uplink time reference group, and determine an uplink transmit time reference based on the licensed spectrum cell and the time difference after it is determined, after the uplink transmit timer expires, that the UE and the base station are asynchronous.

Optionally, in an embodiment of the present invention, the processing module 13 is further configured to determine, based on a Single Cell Point To Multipoint SC-PTM priority, a third cell from the cell group, where the third cell is a cell with a highest SC-PTM priority in the cell group, or the third cell is a cell with a lowest SC-PTM priority in the cell group; and

the receiving module 11 is configured to receive, in one multicast control channel MCCH period by using the third cell, a single cell multicast control channel SC-MCCH message sent by the base station.

Optionally, in an embodiment of the present invention, the processing module 13 is further configured to: after the receiving module 11 receives, in one multicast control channel MCCH period by using the third cell, the single cell multicast control channel SC-MCCH message sent by the base station, determine, based on the SC-MCCH, an SC-MTCH window for sending SC-MTCH information by the base station, and determine, based on the SC-PTM priority, a fourth cell from the cell group; and

the receiving module 11 is further configured to receive, by using the fourth cell, the SC-MTCH information sent by the base station in the SC-MCCH.

Optionally, in an embodiment of the present invention, the receiving module 11 is further configured to: before the sending module 12 sends uplink information to the base station by using the cell group, receive, by using a fifth cell in the cell group, downlink data sent by the base station, where the fifth cell is an unlicensed spectrum cell;

the processing module 13 is further configured to determine a sixth cell from the cell group, where the sixth group is a cell that occurs earliest within a hybrid automatic repeat request window HARQ windows time and that has an available physical uplink shared channel PUCCH opportunity; and

the sending module 12 is further configured to send a HARQ of the downlink data to the base station by using the PUCCH opportunity of the sixth cell.

Optionally, in an embodiment of the present invention, the processing module 13 is further configured to: before the sending module 12 sends uplink information to the base station by using the cell group, determine a channel state indication CSI resource.

Optionally, in an embodiment of the present invention, the receiving module 11 is further configured to receive first CSI resource indication information sent by the base station, where the first CSI resource indication information indicates a time position of the CSI resource; and

the processing module 13 is specifically configured to reserve, based on the first CSI resource indication information, the time position in each cell of the cell group as a position of the CSI resource.

Optionally, in an embodiment of the present invention, the receiving module 11 is further configured to receive second CSI resource indication information sent by the base station, where the second CSI resource indication information indicates a time position of the CSI resource and a seventh cell; and

the processing module 13 is further configured to reserve, based on the second indication information, the time position in the seventh cell as a position of the CSI resource.

FIG. 14 is a schematic structural diagram of Embodiment 1 of a base station according to the present invention. The base station provided in this embodiment may implement the steps of the method that is applied to a base station and that is provided in any one of the embodiments of the present invention. Specifically, the base station provided in this embodiment includes:

a processing module 21, configured to configure a cell group for user equipment UE;

a sending module 22, configured to send configuration information to the UE, where the configuration information indicates the cell group; and

a receiving module 23, configured to receive uplink information sent by the UE by using the cell group.

The base station provided in this embodiment of the present invention configures the cell group for the UE, and sends the configuration information of the cell group to the UE, so that the UE sends the uplink information by using the cell group, to distribute the uplink information to a plurality of cells in the cell group for transmission, thereby implementing high-reliability transmission of the uplink information. In addition, applying the method to a scenario of co-site deployment of an unlicensed cell and a licensed cell can resolve a problem of a limited PCell capacity; applying the method to a scenario of non co-site deployment of an unlicensed cell and a licensed cell can implement uplink information transmission in such a scenario.

Optionally, in an embodiment of the present invention, the uplink information includes uplink information of a first cell; and

the receiving module 23 is specifically configured to receive the uplink information of the first cell sent by the UE by using the first cell;

or,

the receiving module 23 is specifically configured to receive the uplink information of the first cell sent by the UE by using a second cell; where

the first cell is a cell in the cell group, and the second cell is another cell different from the first cell in the cell group.

Optionally, in an embodiment of the present invention, the second cell is an unlicensed spectrum cell; and

the receiving module 23 is specifically configured to receive the uplink information of the first cell sent by using the second cell after the UE determines that the second cell is an available unlicensed spectrum cell.

Optionally, in an embodiment of the present invention, the second cell is an unlicensed spectrum cell; and

the receiving module 23 is specifically configured to receive the uplink information of the first cell sent by the UE by using an available alternative cell of the second cell, where the available alternative cell is determined by the UE from at least one alternative cell of the second cell after the UE determines that the second cell is an unavailable unlicensed spectrum cell.

Optionally, in an embodiment of the present invention, the sending module 22 is further configured to send, in one multicast control channel MCCH period, downlink control information to the UE by using a third cell and a single cell multicast control channel SC-MCCH, where the third cell is determined by the UE from the cell group based on an SC-PTM priority, and the third cell is a cell with a highest SC-PTM priority in the cell group, or the third cell is a cell with a lowest SC-PTM priority in the cell group.

Optionally, in an embodiment of the present invention, the sending module 22 is further configured to send, by using a fourth cell, downlink data information to the UE in a single cell multicast traffic channel SC-MTCH window by using an SC-MTCH, where the fourth cell is determined by the UE from the cell group based on the SC-PTM priority.

Optionally, in an embodiment of the present invention, the sending module 22 is further configured to: before the receiving module 23 receives the uplink information sent by the UE by using the cell group, send downlink data to the UE by using a fifth cell in the cell group; and

the receiving module 23 is configured to receive a hybrid automatic repeat request HARQ of the downlink data that is sent by the UE to the base station by using a PUCCH opportunity of a sixth cell, where the sixth cell is determined by the UE from the cell group, and the sixth cell is a cell that occurs earliest within a hybrid automatic repeat request window HARQ windows time of the downlink data and that has an available physical uplink shared channel PUCCH opportunity.

Optionally, in an embodiment of the present invention, the sending module 22 further sends, before the receiving module 23 receives the uplink information sent by the UE by using the cell group, first CSI resource indication information to the UE, where the first CSI resource indication information indicates a time position of the CSI resource.

Optionally, in an embodiment of the present invention, the sending module 22 further sends, before the receiving module 23 receives the uplink information sent by the UE by using the cell group, second CSI resource indication information to the UE, where the second CSI resource indication information indicates a time position of the CSI resource and a seventh cell.

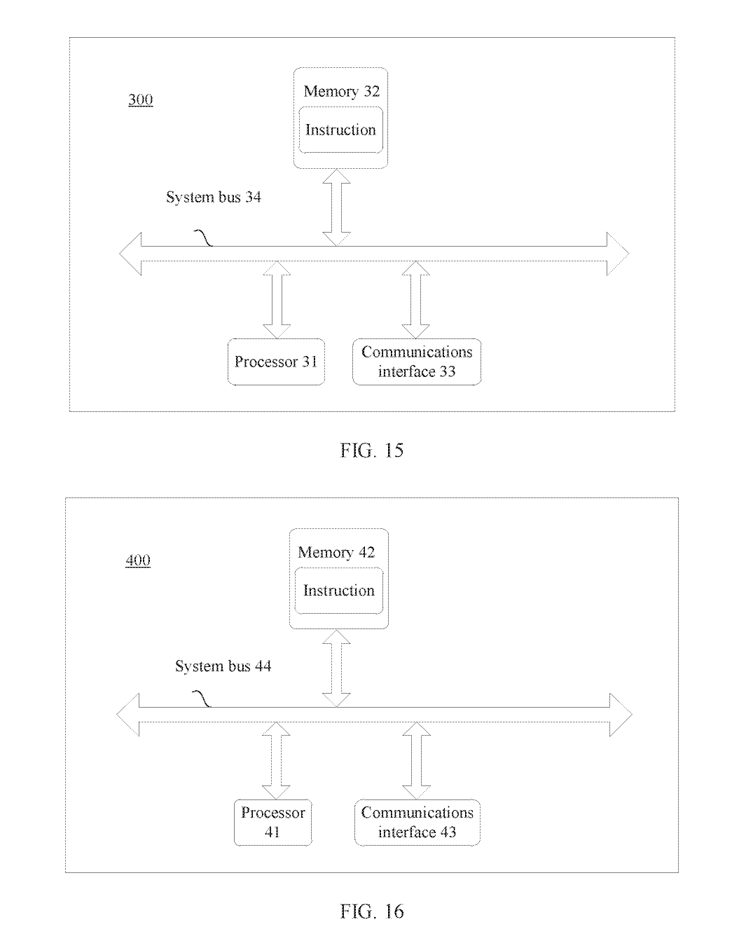

FIG. 15 is a schematic structural diagram of Embodiment 2 of user equipment according to the present invention. The user equipment 300 provided in this embodiment includes a processor 31, a memory 32, a communications interface 33, and a system bus 34. The memory 32 and the communications interface 33 are connected to and communicate with the processor 31 by using the system bus 34, the memory 32 is configured to store a computer-executable instruction, the communications interface 33 is configured to communicate with another device, and the processor 31 is configured to run the computer-executable instruction, to cause the user equipment 300 to perform the steps of the foregoing method applied to user equipment.

FIG. 16 is a schematic structural diagram of Embodiment 2 of a base station according to the present invention. The base station provided in this embodiment includes a processor 41, a memory 42, a communications interface 43, and a system bus 44. The memory 42 and the communications interface 43 are connected to and communicate with the processor 41 by using the system bus 44, the memory 42 is configured to store a computer-executable instruction, the communications interface 43 is configured to communicate with another device, and the processor 41 is configured to run the computer-executable instruction, to cause the base station to perform the steps of the foregoing method applied to a base station.

The system bus mentioned in FIG. 15 and FIG. 16 may be a peripheral component interconnect (peripheral component interconnect, PCI) bus, an extended industry standard architecture (extended industry standard architecture, EISA) bus, or the like. The system bus may be classified into an address bus, a data bus, a control bus, and the like. For ease of representation, only one thick line is used to represent the bus in the figure, but this does not mean that there is only one bus or only one type of bus. The communications interface is configured to implement communication between a database access apparatus and another device (such as a client, a read write database, or a read-only database). The memory may include a random access memory (random access memory, RAM), or may further include a non-volatile memory (non-volatile memory), for example, at least one disk memory.

The processor may be a general-purpose processor, including a central processing unit (Central Processing Unit, CPU), a network processor (Network Processor, NP), and the like; or may further be a digital signal processor (Digital Signal Processor, DSP), an application-specific integrated circuit (Application Specific integrated Circuit, ASIC), a field programmable gate array (Field-Programmable Gate Array, FPGA), or another programmable logic device, discrete gate or transistor logic device, or discrete hardware component.

A person of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. An uplink information transmission method, comprising:
receiving, by user equipment UE, configuration information sent by a base station, wherein the configuration information indicates a cell group configured for the UE by the base station; and
sending, by the UE, uplink information to the base station by using the cell group.

2. The method according to claim 1, wherein the uplink information comprises uplink information of a first cell, and the sending, by the UE, uplink information to the base station by using the cell group comprises:
sending, by the UE, the uplink information of the first cell to the base station by using the first cell:
or
sending, by the UE, the uplink information of the first cell to the base station by using a second cell; wherein
the first cell is a cell in the cell group, and the second cell is another cell different from the first cell in the cell group.

3. The method according to claim 2, wherein the second cell is an unlicensed spectrum cell; and
before the sending, by the UE, the uplink information of the first cell to the base station by using a second cell, the method further comprises:
determining, by the UE, that the second cell is an available unlicensed spectrum cell.

4. The method according to claim 2, wherein the second cell is an unlicensed spectrum cell; and
before the sending, by the UE, the uplink information of the first cell to the base station by using a second cell, the method further comprises:
determining, by the UE, that the second cell is an unavailable unlicensed spectrum cell.

5. The method according to claim 4, wherein the sending, by the UE, the uplink information of the first cell to the base station by using a second cell comprises:
starting, by the UE, a window timer at a time point of sending the uplink information of the first cell;
detecting, by the UE during running of the window timer, that the second cell is available; and
sending, by the UE, the uplink information of the first cell to the base station by using the second cell.

6. The method according to claim 4, wherein
the sending, by the UE, the uplink information of the first cell to the base station by using the first cell comprises;
determining, by the UE, that there is an available alternative cell in at least one alternative cell of the second cell; and
sending, by the UE, the uplink information of the first cell to the base station by using the available alternative cell of the second cell.

7. An uplink information transmission method, comprising:
configuring, by a base station, a cell group for user equipment UE;
sending, by the base station, configuration information to the UE, wherein the configuration information indicates the cell group; and
receiving, by the base station, uplink information sent by the UE by using the cell group.

8. The method according to claim 7, wherein the uplink information comprises uplink information of a first cell, and the receiving, by the base station, uplink information sent by the UE by using the cell group comprises:
receiving, by the base station, the uplink information of the first cell sent by the UE by using the first cell;
or
receiving, by the base station, the uplink information of the first cell sent by the UE by using a second cell; wherein
the first cell is a cell in the cell group, and the second cell is another cell different from the first cell in the cell group.

9. The method according to claim 8, wherein the second cell is an unlicensed spectrum cell, and the receiving, by the base station, the uplink information of the first cell sent by the UE by using a second cell comprises:
receiving, by the base station, the uplink information of the first cell sent by using the second cell after the UE determines that the second cell is an available unlicensed spectrum cell.

10. The method according to claim 8, wherein the second cell is an unlicensed spectrum cell, and the receiving, by the base station, the uplink information of the first cell sent by the UE by using a second cell comprises:
receiving, by the base station, the uplink information of the first cell sent by the UE by using an available alternative cell of the second cell, wherein the available alternative cell is determined by the UE from at least one alternative cell of the second cell after the UE determines that the second cell is an unavailable unlicensed spectrum cell.

11. User equipment, comprising:
a receiving module, configured to receive configuration information sent by a base station, wherein the configuration information indicates a cell group configured for the UE by the base station; and
a sending module, configured to send uplink information to the base station by using the cell group.

12. The user equipment according to claim 11, wherein the uplink information comprises uplink information of a first cell; and
the sending module is specifically configured to send the uplink information of the first cell to the base station by using the first cell;
or
the sending module is specifically configured to send the uplink information of the first cell to the base station by using a second cell; wherein
the first cell is a cell in the cell group, and the second cell is another cell different from the first cell in the cell group.

13. The user equipment according to claim 12, wherein the second cell is an unlicensed spectrum cell; and
the user equipment further comprises:
a processing module, configured to determine, before the sending module sends the uplink information of the first cell to the base station by using the second cell, that the second cell is an available unlicensed spectrum cell.

14. The user equipment according to claim 12, wherein the second cell is an unlicensed spectrum cell; and
the user equipment further comprises:
a processing module, configured to determine, before the sending module sends the uplink information of the first cell to the base station by using the second cell, that the second cell is an unavailable unlicensed spectrum cell.

15. The user equipment according to claim 14, wherein
the sending module is configured to send the uplink information of the first cell to the base station by using the second cell, when the processing module detects, during running of a window timer that is started at a time point of sending the uplink information of the first cell, that the second cell is available.

16. The user equipment according to claim 14, wherein
the sending module is configured to send, when the processing module determines that there is an available alternative cell in at least one alternative cell of the second cell, the uplink information of the first cell to the base station by using the available alternative cell of the second cell.

17. A base station, comprising:
a processing module, configured to configure a cell group for user equipment UE;
a sending module, configured to send configuration information to the UE, wherein the configuration information indicates the cell group; and
a receiving module, configured to receive uplink information sent by the UE by using the cell group.

18. The base station according to claim 17, wherein the uplink information comprises uplink information of a first cell; and
the receiving module is specifically configured to receive the uplink information of the first cell sent by the UE by using the first cell;
or
the receiving module is specifically configured to receive the uplink information of the first cell sent by the UE by using a second cell; wherein
the first cell is a cell in the cell group, and the second cell is another cell different from the first cell in the cell group.

19. The base station according to claim 18, wherein the second cell is an unlicensed spectrum cell; and
the receiving module is specifically configured to receive the uplink information of the first cell sent by using the second cell after the UE determines that the second cell is an available unlicensed spectrum cell.

20. The base station according to claim 18_{;} wherein the second cell is an unlicensed spectrum cell; and
the receiving module is specifically configured to receive the uplink information of the first cell sent by the UE by using an available alternative cell of the second cell, wherein the available alternative cell is determined by the UE from at least one alternative cell of the second cell after the UE determines that the second cell is an unavailable unlicensed spectrum cell.
